(19) United States
(12) Patent Application Publication
(10) Pub. No.: US 2021/0350445 A1
(43) Pub. Date: Nov. 11, 2021

(54) Cryptocurrency Commerce User Interface Systems

(71) Applicant: RocketFuel Blockchain, Inc., Beverly Hills, CA (US)

(72) Inventor: Joseph E Page, Las Vegas, NV (US)

(21) Appl. No.: 16/870,834

(22) Filed: May 8, 2020

(51) Int. Cl. G06Q 30/06; G06Q 10/08; G06Q 20/06; G06Q 20/22; G06Q 20/36; G06K 19/06; G06K 7/10

(52) U.S. Cl. CPC G06Q 30/0635; G06Q 10/0838; G06Q 20/0655; G06Q 20/223; G06Q 30/0641; G06Q 30/0277; G06Q 20/3678; G06K 19/06037; G06K 7/10297; G06Q 2220/00; G06Q 30/0623

(57) ABSTRACT

A method of effecting a purchase order includes accessing from one or more memory devices computer-readable instructions, wherein the computer-readable instructions are executable by one or more processors of a computing device to detect a purchase trigger event. The method also includes recalling a delivery address specification in response to the detecting of the purchase trigger event, forming a cryptocurrency transaction, the cryptocurrency transaction incorporating the recalled delivery address specification therein, and transmitting the cryptocurrency transaction into a peer to peer cryptocurrency network.

### BACKGROUND OF THE INVENTION

### Field

The following invention disclosure is generally concerned with cryptocurrency based commerce systems and more particularly with advertisements fashioned as product offers having full checkout functionality.

### Related Systems

The controversially famous Amazon ‘single-click’invention presented in U.S. Pat. No. 5,960,411, surviving a rigorous 4 year re-examination 90/007,946 to emerge largely unscathed, remains a very powerful concept in e-commerce. The patent will remain in force until September 2017 providing Amazon a very enviable advantage in the e-commerce arena. In brief, an Amazon® customer prepares a profile that includes credit card account details and shipping address. Thereafter, while browsing an Amazon shopping website a so-prepared customer can avoid tedious check out/shopping cart processes by using a ‘single click’ checkout. One click on the appropriate button informs Amazon of their customer's decision to buy a product, further authorizes charges to the credit card on file; and finally specifies the delivery address similarly by way of the customer's prepared profile details.

Amazon is not alone in their efforts to make shopping easy for customers with particular regard to the checkout process. EBay® has operates an instant ‘buy, it now’ feature which similarly permits a customer to skip an auction bidding process and invoke an instant sale transaction. Payment and shipping details follow immediately after a website user exercises the ‘buy U now’ feature.

The PayPal component of eBay also permits storage of a delivery address whereby a known customer can avoid repeatedly entering shipping details as that information may be recalled from a profile maintained memory registers.

A new and interesting system based upon distributed cryptography includes a cryptocurrency known as ‘bitcoin’. While primarily a currency, bitcoin additionally includes many important features which are fairly characterized as entire payment transactional systems. The bitcoin peer-to-peer network has quickly risen up to become far more than mere currency. While still quite in its infancy, supporting system which integrate with the remarkable features of bitcoin come forth daily and probably will continue for some time into the future.

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented here following.

It should be understood that all of herein referenced materials including those set forth in appended information disclosure statement provide considerable definition with regard to elements of these inventions. Therefore, those materials are incorporated herein by reference whereby this specification can rely upon them for enablement of the particular teachings of each.

E-commerce websites on which consumers may purchase goods for delivery are typically complex systems comprised of many components and interoperating elements. Specifically, these websites almost always include a sophisticated and highly secure checkout system. Because consumer payment card information is being handled, advanced security precautions must be adopted to protect consumers against fraud. Indeed nearly all merchant e-commerce websites include a cooperation between several web services—in particular the functions offered by a payment processor service. Information from a consumer is received at a merchant computer server and reformatted into specific forms and transmitted onto a payment processor API for example to gain approval for the transfer of funds.

Payment is not the entirety of the checkout process. Consumers must inform merchant and/or vendors where they would like to have products shipped. The second stage of conventional checkout processes typically includes delivery details.

Because the checkout process is quite complex, commercial transactions are limited to special purpose websites which include advanced facilities for payment processing and shipping or fulfillment arrangement. For these reasons, among others, most websites are not arranged as e-commerce sites in which users can make purchases of goods.

Facebook for example is a most popular website enjoyed by the masses but cannot be used to purchase goods Facebook is a social media website. While advertisements for products may include links to related-commerce websites, products cannot be purchased directly from within the Facebook infrastructure. Facebook has yet to integrate effective payment systems and neither does it have sufficient couplings to payment processors. To offer commercial transactions at Facebook webpages, the administration would have to prepare an internal payment system equivalent in scope to PayPal or to integrate with sophisticated payment card processors for example. Further, Facebook would have to establish a fulfillment center on the scale of the remarkable system created by Amazon. It is not within the immediate interests of Facebook to adopt the PayPal and Amazon type systems into their platform Facebook enjoys being the non-phis-ultra social media website without the difficulties of administering payments and product fulfillment tasks. Facebook is a social media website. As a consequence, presently one cannot purchase goods from within Facebook.

Common ‘blog’ websites typically have topic specific text and image content in an ongoing thread of article posts. Because offering commercial products in a website is very complex, blog websites typically do not include any means by which blog readers can make purchases of products. Rather, advertisements in blog websites (which are quite common) include hyperlinks that forward a user's web browser away from the blog website and onto a commerce website which has integration of payment and shipping checkout schemes. In some cases a blog site operator may receive a referral fee or affiliate commission, but generally all contact with a consumer is lost once the browser is redirected from and leaves the blog website Heretofore, it has been extremely difficult to conduct commerce directly from within a blog website with few exceptions.

The controversially famous Amazon ‘1-click’ invention presented in U.S. Pat. No. 5,960,411, surviving a rigorous 4 year re-examination 90/007,946 to emerge largely unscathed, remains a very powerful concept in e-commerce. The patent will remain in force until September 2017 providing Amazon a very enviable advantage in thee-commerce arena.

In brief, an Amazon customer prepares a profile that includes credit card account (payment) details and shipping address specification. Thereafter, while browsing an Amazon shopping website a so-prepared customer can avoid tedious check out/shopping cart processes by using a ‘1-click’ checkout user interface. A single click on the appropriate command button informs Amazon of their customer's decision to buy a product, further authorizes charges to a credit card on file; and finally specifies the delivery address similarly by way of the customer's prepared profile details.

Amazon is not alone in their efforts to make shopping easy for customers with particular regard to the checkout process. EBay® has operates an instant ‘Buy It Now’ feature which similarly permits a customer to skip an auction bidding process and invoke an instant sale transaction. Payment and shipping details follow immediately after a website user exercises the‘Buy It Now’ command.

The PayPal component of eBay also permits storage of a delivery address whereby a known (logged in) customer can avoid repeatedly entering shipping details as that information may be recalled from a profile maintained in memory registers.

A new and interesting system based upon distributed cryptography includes a cryptocurrency known as ‘Bitcoin’. While primarily a currency, Bitcoin additionally includes many important features which are fairly characterized as supporting entire payment transactional systems. The Bitcoin peer-to-peer network has quickly risen up to become far more than mere currency. While still quite in its infancy, supporting systems which integrate with the remarkable features of Bitcoin come forth daily and probably will continue for some time into the future.

While systems and inventions of the art are designed to achieve particular goals and objectives, some of those being no less than remarkable, these inventions of the an have nevertheless include limitations which prevent uses in new ways now possible.

Inventions of the art are not used and cannot be used to realize advantages and objectives of the teachings presented here following.

It should be understood that all of herein referenced materials including those set forth in appended information disclosure statement provide considerable definition with regard to elements of these inventions. Therefore, those materials are incorporated herein by reference whereby this specification can rely upon them for enablement of the particular teachings of each.

### SUMMARY OF THE INVENTION

Comes now, Jos. E. Page with inventions of commerce systems based upon cryptocurrency protocols including devices, methods and articles of manufacture arranged to effect commercial transactions. It is a primary function of these special commerce systems to provide highly efficient interfaces for making commercial transactions with cryptocurrency, the system having integrated delivery support.

It is a contrast to prior art methods and devices that systems first presented here do not require purchases to be made at a merchant website but rather on independent third party websites and other locations not directly connected to a conventional merchant's commerce website among others.

Cryptocurrency based commerce systems having advertisements or other product offers arranged to carry information in support of a special purchase order that can be conveyed entirely over a cryptocurrency network blockchain are presented. Specifically, these advertisement and product offer devices and methods are prepared to carry product selection encoding schemes, transaction value, delivery information, optionally encryption keys, in addition to conventional product text and images descriptions, et cetera in some versions, commerce systems taught herein carry prescribed cryptocurrency addresses which have a priori been associated with products and product configurations as declared by a merchant administrator.

When served as part of a webpage, advertisements in conformance with these teachings pern lit consumers to instantly invoke purchases via a single-click on a command button type web control or user interface arranged as a purchase trigger for example, whereby parametric data carried by the device is used by a local or ‘client-side’ cryptocurrency wallet to formulate special purpose Bitcoin transactions having incorporated therein shipping information. These specially prepared cryptocurrency transactions can carry product selection information and consumer delivery address information included therein. As such, these devices, methods and articles are entirely autonomous and do not rely upon any direct communications link to a merchant website nor payment processor website. Rather, these special purpose Bitcoin transactions as they appear on the blockchain constitute the entire purchase order.

Merchants monitor the blockchain to detect arrival of purchase orders (special Bitcoin transactions) of these systems on their known addresses—for example addresses having been previously associated with particular products and/or product configurations. In view of the particular addresses used, merchants implicitly understand the products and product configurations chosen by their customers. Further, a data payload portion of the transaction as it appears on the blockchain reveals the customer's shipping address and shipping preferences. A merchant is then in position to immediately fulfill the purchase order and dispatch delivery thereof by courier direct to the customer's home for example.

### Objectives of the Invention

It is a primary object of the invention to provide cryptocurrency based commerce systems having delivery specifications integrated with transactions.

It is an object of the invention to provide cryptocurrency based commerce systems having user interfaces with parametric specifications for use in forming cryptocurrency transactions.

It is a further object to provide highly efficient autonomous commerce system advertisements and ordering platforms.

It is further an object to provide commercial platforms indirectly coupled to fulfilment centers by a cryptocurrency blockchain.

It is an object to enable special purpose commerce platforms communicatively disconnected from merchant entities.

It is an object of these systems to provide means of electronic commerce whereby purchase order specifications are entirely encoded in a cryptocurrency transaction.

A better understanding can be had with reference to detailed description of preferred embodiments and with reference to appended drawings Embodiments presented are particular ways to realize the invention and are not inclusive of all ways possible Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where.

FIG. 1 presents a most simple HTML only version of user interfaces of these devices,

FIG. 2 is an illustrative example of a web control type user interface system having a purchase trigger;

FIG. 3 is another example showing a visual implementation of web control user interfaces in accordance with the teachings herein;

FIG. 4 is a diagram to illustrate important non-visual aspects of web control devices of these teachings:

FIG. 5 is a block diagram which specifies elements of a web control device of these systems;

FIG. 6 is a block diagram which specifies methods and primary steps thereof,

FIG. 7 is a block diagram to illustrate articles of manufacture in conformance with the teachings presented herein,

FIG. 8 is another diagram illustrating an important type of user interface operable for use in these systems,

FIG. 9 is an illustration of a social media website in which these systems may be deployed;

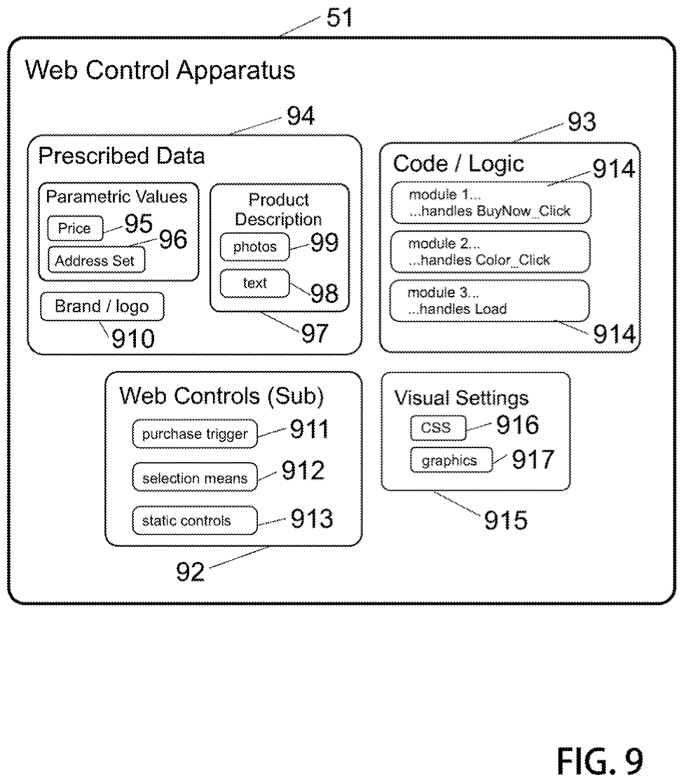

FIG. 10 illustrates a method of making a purchase order according to some embodiments;

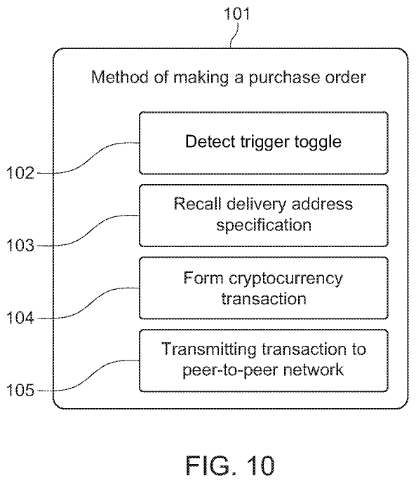

FIG. 11 illustrates an article of manufacture including modules according to some embodiments,

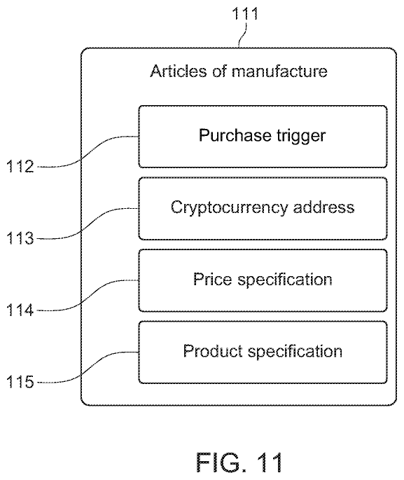

FIG. 12 illustrates versions in which a simple command type button is integrated within user interfaces that are deployed according to some embodiments; and

FIG. 13 illustrates a webpage instance for a social media file/website according to some embodiments.

### GLOSSARY OF SPECIAL TERMS

Throughout this disclosure, reference is made to some terms which may or may not be exactly defined in popular dictionaries as they are defined here. To provide a more precise disclosure, the following term definitions are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations.

### Cryptocurrency Transaction

A cryptocurrency transaction is a specification in conformance with a cryptocurrency protocol for example the Bitcoin protocol which effects a transfer of value from at least one address to at least one other address.

### Web Control Object

A web control object is arranged as a web page component having functional capabilities enabled by associated stored program code executable on a general purpose computer system in conjunction with execution of web browser software. A web control object may contain therein a plurality of other web control objects, or ‘sub controls’ also having functions brought about by associated stored code. For purposes of this description, some web control objects are arranged as commercial advertisements.

### Carrier Wave Signal

A carrier wave signal is a physical construct embodied as an electromagnetic wave formed to carry information by way of either spatial or temporal modulation. For purposes of this specification, a carrier wave signal is an article of manufacture in which the particular modulation gives rise to a device having specific function and performance.

### DETAILED DESCRIPTION AND PREFERRED EMBODIMENTS

In accordance with each of preferred embodiments of the invention, commerce systems based upon cryptocurrency payments with integrated delivery information are provided. It will be appreciated that each of the embodiments described include an apparatus and that the apparatus of one preferred embodiment may be different than the apparatus of another embodiment. Accordingly, limitations read in one example should not be carried forward and implicitly assumed to be part of an alternative example.

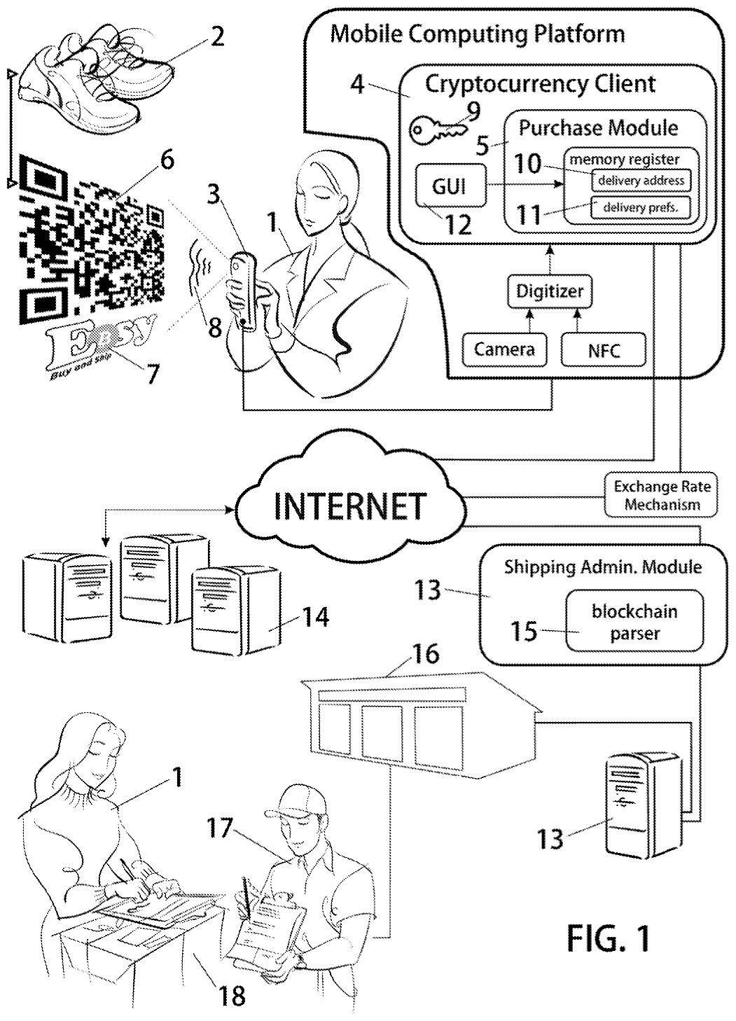

FIG. 1 illustrates an important illustrative version and implementation of these systems in a scenario diagram. A consumer-buyer 1 of retail products 2 enjoys the ease and security of using personal computing platforms such as a handheld mobile phone 3 initiated with special-purpose application software which includes a unique cryptocurrency client 4 with a novel purchase module 5 component.

A consumer in possession of a so-equipped mobile phone may use it to address a highly specialized printed object or‘tag’ which is associated (usually by proximity) with a retail product of interest offered for sale and may include a spatially modulated pattern sometimes in the form of a ‘QR Code’ 6 and optionally branding indicia 7 suggesting an EasyBitcoin ‘buy and ship’ function.

While many sophisticated consumers are familiar with common QR codes, they cannot know whether these QR codes enabled special purpose functions such as the ‘buy and ship’function described herein whereby integrated delivery address information enables shipping administration to automatically deliver goods and services to a customer via a preprogrammed prescribed address.

It is usually impossible for a consumer to read the content by looking at a common QR code. A branding logo like the one shown serves to instantly alert customers that the retailer has enabled special quick delivery mechanisms and the consumer understands instantly that the product can be received at the user's prescribed postal address in conjunction with use of this particular marked optical device.

Similarly, the QR code itself may also provide for an indicator of availability of the same ‘buy and ship’ function. In some versions of these systems, it is advantageous for the cryptocurrency client (machine) to be responsive to optical patterns arranged to indicate enablement and availability of the automated shipping feature. In other words, the customer's client software in made responsive to the fact that a retailer is prepared to process transactions in accordance to the schemes having automatic shipping. To achieve this, a QR code may include a device herein known as a ‘function toggle’ For example a single Boolean data value which signals the availability of the advanced delivery function to the microprocessor and code being executed thereon. Where a scan of the QR code reveals a ‘true’ value, the software can respond accordingly by invoking supporting methods with the understanding that downstream systems will be able to respond appropriately. In one example, where a QR code indicates to a cryptocurrency module that ‘buy and ship’ functionality is enabled, a purchase module will respond by preparing a cryptocurrency transaction specification which includes a customer's delivery address.

In some important versions, the mobile phone ‘scans’ the QR code by way of an imager (or camera) which receives a carrier wave signal in the form of a spatially modulated optical wave or which includes necessary encodings. In particular, a cryptocurrency address, price value (optional), a product ID (optional), function toggles (optional), among other optional specifications. A wide array of data useful for affecting a retail sale transaction and delivery instructions may be included in a single well prepared QR code.

QR codes are not the only optical devices which may be used to encode these data in support of automated retail shipping functionality. Simple single dimension barcode optical devices may also be used to convey information to mobile computing platforms operated by consumer shoppers Non-optical versions are also useful in some alternative arrangements A most useful system includes a technology commonly referred to as ‘NFC’ or ‘near field communications’. Sometimes these systems are similarly referred to as RFID-or ‘radio frequency identification’. A near field communications server/scanner may be built into the chassis of a mobile telephone and it may be used to capture carrier wave signals of these systems which support retail transactions where a cryptocurrency payment formed in conjunction with information from the tag include a delivery address encoded therewith. For systems implemented with an NFC scanner, the carrier wave signal is embodied as a radio wave rather than an optical wave.

In both cases, a carrier wave signal 8 carries an encoding of information necessary to bring about a ‘buy and ship’type retail sale transaction. Minimally, a carrier wave signal of these systems must include a cryptocurrency address which can receive funds for the benefit of the seller/retailer.

In addition, versions will include a specified sale price. A set price expressed numerically in a default denomination is a convenient way to indicate to a cryptocurrency client the amount which should be included in a cryptocurrency transaction specification.

While some modes will include prices set in ‘bitcoin’ currency units, this is not necessary for operation of these systems. Indeed any denomination is suitable. Where a non-cryptocurrency or fiat currency denomination is specified, a conversion is preferably made in a process prior to transmission of a cryptocurrency transaction specification to the peer-to-peer network. This is necessary as presently cryptocurrency systems do not support transactions in diverse denominations. A well formed bitcoin transaction is necessarily specified in stated bitcoin quantity.

However, in these commerce systems it is important to relieve retailers of the complexities and inconveniences of performing currency conversions and managing dynamic exchange rates. For this reason, the systems are specifically arranged to accommodate sale prices stated in dollars or euros or other fiat currencies whereby a conversion to cryptocurrency value units is performed within the purchase module just prior to formulation of a cryptocurrency transaction specification. Where retailers are comfortable executing transactions in cryptocurrency units, they may prefer to stay prices denominated in bitcoin for example.

Further, some versions include a product ID indication which might help these special cryptocurrency clients be more responsive. For example, a certain product ID may trigger a user interface to solicit a color choice or size choice associated with the product. If a product comes in various sizes and colors, a product ID can be used in conjunction with branching code executed at the client to indicate these consumer choices among others.

In an alternative version, a unique cryptocurrency address may be allocated for each size/color combination possible. Payment transmission to these respective addresses implicitly includes the consumer selection of color/size simply by way of the unique addresses associated with the combinations. This however is a bit less convenient as it necessitates the user select the correct QR code from an array of possibilities and scan that version.

Modem mobile telephones often include both imager and NFC components. These systems are based upon advanced transducers operable for scanning a carrier wave signal in the form of electromagnetic waves and converting same by way of a digitizer to an electronic digital signal process able by the computing platform logic processor. The cryptocurrency client receives these digitized signals and combines them with other information to form cryptocurrency transaction specifications in accordance with the teachings presented here to realize a convenient automatic shipping feature for retail commercial systems. For example, in order for a complete well-formed cryptocurrency transaction specification to be made, a signing key 9 associated with a funded cryptocurrency account (public key) must be used to sign the transaction.

Further user specific profile information stored in a memory coupled to the cryptocurrency client may be used to form some cryptocurrency transactions. Accordingly, information received via these carrier wave signals forms basis in-part for the cryptocurrency transaction specifications produced by the special cryptocurrency client presented in detail here throughout. Cryptocurrency transaction specifications of these systems are particularly unique because they include delivery information. In best modes, purchase modules use information received from a scan of a tag object (QR code device or NFC devices) and combines that with information relating to delivery—for example recipient's address. Special memory registers include prepared data relating to delivery. Namely, a delivery address (recipient's address) 10 and delivery preferences 11. A delivery address may be a postal address specification or an electronic address such as an e-mail address or URL (cloud storage). These addresses specify a unique place where the user can receive deliveries of goods and/or services. Delivery preferences may include selections with regard to express mail services like FedEx or UPS-expedited overnight service, second day ground, or other similar delivery options.

These parameters may be initialized to suit a particular user by way of a graphical user interface 12 which a user can operate to initialize her system. Once a mailing address is supplied for example, that address can be used as a default for every purchase effected by the user thereafter. All payments made with a system so initialized may include a mailing address supplied therewith. When a cryptocurrency payment is conveyed to the peer-to-peer network, it can have encoded directly therein the user's delivery address Retailers who receive payments with delivery addresses integrated therewith the payment transaction code, can process those payments by performing an instant or automated delivery action without further information from the buyer. Buyers enjoy not having to repeatedly supply their mailing address while making purchases. Presently, Internet e-commerce shopping carts systems typically end with a selection of delivery service and entry of a post office address for purposes of effecting delivery. A very tedious process when repeated many times. Conversely, a consumer who uses systems described herein merely has to approve payment and the resulting payment transaction has the buyer's delivery address automatically integrated therein the payment transaction specification.

When using the system to have products delivered, a user merely scans a QR code, presses an approval or ‘okay’ button confirmation, and expects receipt of goods and services on the default address in due course. After a consumer scans a label associated with a product the consumer wants to purchase, pay for, and receive delivery thereof, the cryptocurrency client operates to form a special cryptocurrency transaction specification which includes a delivery address therein. After the cryptocurrency transaction specification is so prepared by the cryptocurrency client, the client transmits this special transaction into the cryptocurrency network to be included in the public register or ‘blockchain’.

Because the newest version (October 2013) of the bitcoin protocol will soon include provision for a special data payload in the transaction field defined as an 80 byte packet data holder, the ‘OP_RETURN’ field, the bitcoin blockchain is now ideal vehicle for bringing about these special commerce systems A well-formed bitcoin transaction including for example an OP_RETURN field arranged to carry a delivery address along with a conveyance of payment perfectly enables these systems.

To cooperate with these systems, a retailer arranges his order processing administration 13 to monitor the bitcoin blockchain maintained in the peer-to-peer network 14. When a payment is detected on an address known to be owned by the retailer, the retailer may further parse 15 and decode the transaction for delivery information. Since the transaction on a known address will include a customer's delivery address and optional delivery parameters, the retailer knows precisely where to deliver the goods and/or services associated with that payment. Without more, the retailer receives a payment and dispatches goods. It is not necessary after initialization for either the buying or selling party of these transactions to fuss with delivery instructions and addresses. These are automatically conveyed with payment by the cryptocurrency blockchain and more precisely in a special data field therein.

### Address Encryption Schemes

In some versions it is preferable to conceal for security purposes the delivery address. Because the blockchain of popular cryptocurrency systems are completely disclosed and public, all interested persons have access to data therein. In event of a large value purchase, for example a diamond ring for over 500BTC (‘BTC’ is sometimes and herein used to designate units of bitcoin cryptocurrency), it may be preferable for the buyer and the seller to avoid advertising the fact that a delivery will soon occur at a specified physical address. Accordingly these versions include schemes to encrypt or at least obfuscate the data which yield delivery address information. Because cryptographic function and apparatus are readily available in computing platforms described here, it is convenient to use two-party asymmetric cryptographic schemes (public key/private key) to encrypt delivery address data fields in these transactions. In this way, only the seller is able to discover the clear text version of a delivery address of the buyer as the decryption of the suitably encrypted delivery address requires the private key held solely in possession of the seller. In these versions, the cryptocurrency client of the buyer forms a cryptocurrency transaction with a delivery address contained in the OP_RETURN <data> field. However, the delivery address is not represented as clear text, but rather is encrypted in view of the buyer's private key. When a seller receives the encrypted address by the way of the blockchain public register, only he is able to decrypt the address in a clear text form as holder of the necessary private key.

With a delivery address in clear form, the retail seller may dispatch delivery from a shipping facility 16. A delivery agent 17 arrives at the specified delivery address to present the buyer with purchased goods 18. After initialization of the mobile phone, the buyer no longer has to provide retailers with delivery information as that information is automatically conveyed with payments

### Methods

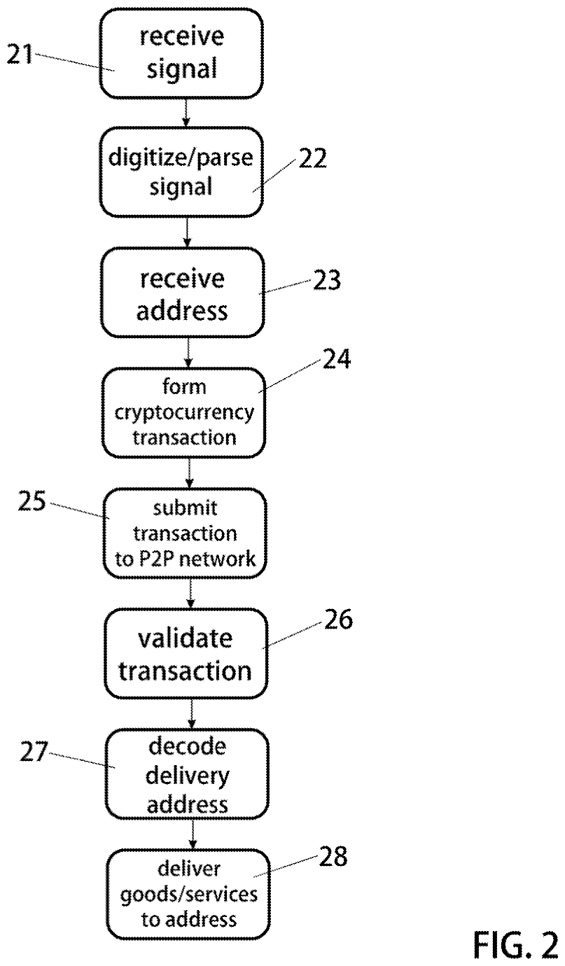

These commerce systems having automated delivery address features include in part methods of effecting a purchase order whereby the delivery address is retrieved from a memory and integrated with a cryptocurrency payment transaction. These methods in general include the steps: receive signal; digitize received signal; recall delivery address, form cryptocurrency transaction specification with delivery address integrated therewith; submit transaction to cryptocurrency peer-to-peer network. Further, methods may additionally include steps whereby a sellers shipping administration facility is enabled with means to monitor and parse a cryptocurrency blockchain and to prepare shipments to addresses found therein. As such the steps; validate transaction and deliver goods/services may also be appended to the steps described above. A better understanding is had with reference to drawing of FIG. 2.

In a first step, a carrier wave signal is received 21 by an interested buyer at her mobile computing platform, for example her mobile telephone equipped with a camera type integer or NFC touch communication system.

The carrier wave signal originates from a device (‘tag’) prepared by the retail seller. The retail seller may prepare these tags to be associated with articles for sale whereby these tags include at least a cryptocurrency address on which payment for goods and services may be received. A retailer must use a cryptocurrency address (pubic key) for which she has control and access by way of complementary signing key. The tag is encoded with the public portion of the key pair. Payments transmitted to the address may be retrieved by the holder of the private key (retailer). These tags may be arranged as optical devices such as QR codes and/or barcodes for example or alternatively as radio transmitter/reflector devices sometimes called RFID or NFC devices. In either case, the tag causes a modulated carrier wave signal to emanate therefrom in a manner whereby it may be received at a simple mobile system such as a handheld telephone.

In preferred versions, these tags may also include a visual cue that special functionality is enabled in conjunction with these particular tags which may otherwise appear as conventional QR codes. It is useful for users to identify these special function tags and for this reason brand labels or other labels embodied as nicely printed text and graphics notifies users that special delivery function is available with regard to sales of products associated with the so marked tags.

These tags carry encodings for information including at least a cryptocurrency address on which a retailer may receive payments. In addition, these tags may also optionally carry encodings for product ID; color, size; price; function toggles; reference URLs; among others. The retail seller must carefully prepared these tags to include these information elements in accordance with a scheme understood by corresponding application-specific software (‘apps’) to be executed on a buyer's mobile computing platform. These tags may be arranged to stimulate conventional systems however in most cases only those systems having a priori knowledge of encoding schemes will be able to understand encodings carried by the tag and respond appropriately thereto.

In a second step, a buyer-user addresses these so-prepared tags in a fashion whereby a carrier wave signal is received at the device Either a camera type integer or NFC touch system receives the signal and converts it from analog form to a digital electronic signal which is processable by a logic processor. The signal from the retailer's tag is received in the digitizer 22 at the buyer's mobile phone for example. So digitized, the signal is parsed into constituent parts and elements are conveyed to the cryptocurrency client for use in forming specialize d cryptocurrency transaction specifications particular to this teaching.

In another step, a purchase module recalls a preprogrammed delivery address from memory or alternatively received a delivery address manually by way of a user interface. The delivery address is an address at which the buyer would like to receive delivery of goods or services being purchased. While delivery address specifications are certainly most likely to be characterized as postal or mailing addresses for most versions of the systems, e-mail addresses and/or URLs for example an FTP address or ‘cloud’ storage site may also be considered ‘delivery address’ for purposes of these inventions and these types are fully anticipated for use in some versions of the systems.

Upon receipt of cryptocurrency payment address (seller's public key), optional sale transaction data (i.e. price), and a buyer's delivery address 23, a following step of general methods includes forming a cryptocurrency transaction specification 24. These information elements may be encoded as a cryptocurrency transaction in agreement with prescribed protocol such as the bitcoin protocol.

Specifically, a bitcoin transaction is formed by declaring one or more outputs of previous transactions recorded on the blockchain as a source of funds to be conveyed. A buyer therefore must have an established history on the blockchain and the cryptocurrency client must be able to reference these prior transactions to indicate where the funds will come from. This can only be done if the cryptocurrency client is in possession of the buyer's cryptocurrency account private or signing key. Once a source of funds is set forth properly, a buyer's cryptocurrency client sets forth in the transaction being formed the destination address. This address is the public key address received by way of decoding the retailer's tag associated with the product being purchased.

In most preferred versions, the QR code or NFC tag additionally conveys a price set by the retail seller. While some versions do not include a price, it is preferable to define a price to be paid for the goods and services being sought by the buyer.

The cryptocurrency client includes a price received from the carrier wave or otherwise specified manually by the buyer, or a prescribed nominal price—e.g. 0001 for example, in preparation of the transaction being formed. A valid well-formed transaction specification must include some non-zero price to be conveyed.

Well-formed cryptocurrency transaction specifications also generally include an address to which any change (excess amounts from stated inputs—outputs) may be returned. Additionally, a transaction should specify a fee amount for processing on the network. These two values may be set in a conventional sense with special consideration for other aspects of the system.

A major information component to be included in these cryptocurrency transaction specifications includes a buyer's address for delivery. The buyer's delivery address may be encoded into the standard bitcoin transaction in several alternative ways.

In a first less than ideal way, the delivery address information may be ‘disguised’ as a micro-payment to a dummy address which is part of a multiple output scheme. The dummy address doesn't actually correspond to any real bitcoin address in the sense that it corresponds to an established bitcoin account, rather the payment of very little value operates as nothing more than a data vehicle indeed the micro-value is forever lost as an understandable output recorded in the UTXO portion of the blockchain system. Since a single cryptocurrency transaction may include payments to several parties, it is possible to encode delivery address data—as if it were a valid bitcoin address in conformance with standard bitcoin address protocol. However, the bitcoin address is merely a encoding of a postal address and the bitcoin payment serves merely as a data carrier. Properly decoded by well advised systems, the bitcoin address can be converted back into a complete postal address. These types of transactions while perfectly functional to nevertheless include some undesirable side effects that might preferably be avoided. For this reason, a recent modification to the bitcoin protocol provides a much more elegant solution for inserting data into common bitcoin transactions whereby the data is only parsable to systems aware of the encoding scheme but do not otherwise affect the bitcoin core processing.

Particularly the OP_RETURN <data> field is ideally suited for storage of a delivery address directly within a cryptocurrency payment. A buyer's delivery address for example a post office address is recalled from a memory register. So recalled, the address may be encrypted into a single alphanumeric string for example by way of a hash function. In one preferred version, a SHA512 hash is applied to the data which sets forth the postal address resulting in an output suitable for containment (with some metadata) in the 80 byte data field. So encrypted, the data field is obfuscated and appears as random values which cannot easily be understood by human observers. However, upon proper decryption, the postal address in its clear form is returned. After the transaction is well formed in accordance with the bitcoin protocol or other cryptocurrency protocol, it is thereafter conveyed by the buyer's mobile phone into the peer-to peer cryptocurrency network. Because modem cellular telephones nearly always include a coupling to the Internet via a TCP/IP interface or gateway, the cryptocurrency transaction specification formed in accordance with the preceding description is readily transmitted or broadcast in accordance with the nature of the cryptocurrency processing for inclusion in the bitcoin blockchain. These steps, taken collectively form the foundation and general case of methods of these inventions.

However, further defined methods include steps taken by the selling party in response to presence of a so formed transaction on the public blockchain. Appearance of a transaction in accordance with this description on the blockchain sets into motion actions by the selling party to complete these processes. Namely, the transaction is confirmed and validated 26. The selling party considers the state of the blockchain and in view of specified criteria with respect to blockchain state declares the transaction valid.

Upon validation of the transaction, the seller decodes 27 the delivery address which appears in the blockchain preferably at a data field provided for recording delivery addresses. Once a delivery address is decoded, the seller triggers a delivery operation 28 to cause goods and/or services to be conveyed to the delivery address. This completes a most important version of the processes.

### No Value Transact Ions

Very special versions of the systems include those in which there is a no value ‘buy’ action. These versions are useful for ‘giveaway’ schemes where a retailer or advertiser wants to deliver goods or services to a customer gratuitously. In such cases, no price value need be indicated in a tag prepared by the retailer Rather, a mere cryptocurrency address may be encoded by the QR code (or other means) to indicate the cryptocurrency client to which address a this special communication which indicates the ‘buyers’ assent ion to accept the offer without payment be directed. This communication is fashioned as a cryptocurrency ‘payment’ transaction and includes a delivery address of the accepting party. However, the payment value may be zero or a near zero nominal amount (i.e. 0.0001 BTC). In addition, a network fee may be paid to assure the transaction is processed by miners to be included in the blockchain. As the transaction for minimal or zero value still carries the delivery address encoded therein, the retailer/advertiser still knows where to convey goods and services or other gratuity. These systems will be especially useful for persons who wish to receive material by e-mail. Such as the brochures travel agencies like to use to promote trips. A quick QR code scan and confirmation click on the cryptocurrency module graphical user interface, and the user can expect quick delivery of promotional goods and services without charges or will cost.

While most convenient versions envisioned include those whereby a tag is associated with a retail product by proximity in a showroom for example, alternative versions are equally important. Showroom-less retail systems for exempt e-commerce websites also enjoyed deploying online versions of these systems. In this case, QR code type tags are preferred to NFC tags as QR code tags are readily compatible with webpage elements such as web control objects fashioned as image fields. Accordingly, online web shopping sites stand to benefit greatly from the advantages provided by these systems. Indeed shopping cart-less e-commerce sites are well enabled by these commerce systems. The payment aspect is handled by a cryptocurrency conveyance and shipping information is encoded directly within the payment transaction. Cumbersome checkout devices may be entirely avoided. A buyer may merely scan the QR code to receive a seller's cryptocurrency address information and the cryptocurrency client may encode the transaction to include the buyer's delivery instructions. Upon receipt of so encoded payments, the seller can ship directly to the user-without more.

In one illustrative example version, a QR code device is arranged to carry all information necessary for a‘buy and ship’ purchase transaction in agreement with these teachings.

A QR code (example above) is encoded as a two dimensional binary array which decodes to the following alphanumeric string:
BA=1EasytRSiWf gz5miX6JraQwciZeQSbPuAR&P=45PID=44758&EB=1

For purposes of some versions of these purchase systems, this string is suitable for perfectly specifying a sales transaction.

The payment address is marked by the identifier “BA=” and the cryptocurrency address of the retail seller is:
1EasytRSiWfgz5miX6JraQwciZeQSbPuAR

Of course the identifier “BA=” is rather arbitrary and is specified by a system designer as a unique label to aid in parsing operations. The value of the address itself may specify a unique address in accordance with any particular cryptocurrency addressing scheme. For the bitcoin network, addresses are necessarily 34 alphanumeric characters where the leading character is ‘P’. For the example developed here the retailer's bitcoin address is:
1EasytRSiWfgz5miX6JraQwciZeQSbPuAR

The string developed in this illustrative example further specifies a transaction value or purchase price. This is set forth as:
P=4.75

The operator ‘&’ is used to separate parameters in the string. While other characters may be selected to operate as a parameter separator, many common encoding schemes use the ‘&’ character and it is convenient to do so similarly here.

While a currency type or denomination may additionally be specified via optional parameter (not used in the example) a default currency may be adopted by convention. Therefore, the example anticipates the currency type as bitcoin. The price of the item being purchased is therefore 4.75 bitcoins. At today's bitcoin values this is considerably high price for typical pairs of shoes; perhaps shoes in the example are from the Christian Louboutin collection.

Another parameter carried by the string relates to product identity. As an optional parameter, some versions of the systems include a product ID value to indicate to a merchant the particular product selected by the purchaser. In this case, a product ID of 44758 is specified.

Finally, some versions include a value to specify the intended servicetype. The captured string includes ‘EB=1′. This indicates that the consumer desires the Easy ‘buy and ship’ service option. So indicated, the purchase module responds by preparing the correct type of cryptocurrency transaction to be published and broadcast on the peer-to-peer cryptocurrency network.

Once a QR code provides a suitable alphanumeric string to the purchase module of a suitably arranged cryptocurrency client such as that described above, the purchase module parses the string and uses parameter information therein to fashion the appropriate cryptocurrency transaction. In particular, the purchase module of the cryptocurrency client which includes a prepared memory register having therein information particular to a specified user's delivery address. This delivery address may correspond to either electronic delivery or postal delivery such as an e-mail address for electronic delivery of goods and services or a postal address for physical delivery of packages by postal worker or other delivery services.

The memory register of the purchase module may be initialized by users who use a graphical user interface to input information such as delivery addresses. So prepared, a purchase module with specified delivery address information is enabled to receive encoded data that specify purchase actions such as the one described above.

Upon receipt of information from an alphanumeric encoding which specifies a purchase action, the purchase module operates to use the information contained therein as well as previously recorded delivery address information among other stored information to form a cryptocurrency transaction specification in accordance with the protocol of a preferred cryptocurrency network. In an illustrative example, a bitcoin transaction may be formed to specify transfer of payment from one party to another party whereby that bitcoin transaction includes delivery information as well.

While versions of these systems described so far are directed primarily to retail commerce sometimes characterized as ‘brick-and-mortar’ retail, it is important to note systems presented are also very useful for websites arranged as ‘e-commerce’ sites having goods and services for sale thereon. This is particularly the case in view of the modern ‘shopping cart’ methodology commonly deployed on e-commerce sites and used for payment and shipping handling. Nearly every purchase on the Internet concludes with the tedium that is manually inputting credit card information and a delivery address via keypad entry. Accordingly, there is a very long felt need in the e-commerce arts and industries to obviate and omit need for the shopping cart checkout methodology on shopping websites.

In view of the teachings first presented herein. Internet based retailers can now completely eliminate the shopping cart checkout paradigm. This is easily understood in consideration of the two primary functions performed by shopping cart checkout systems: payment and shipping.

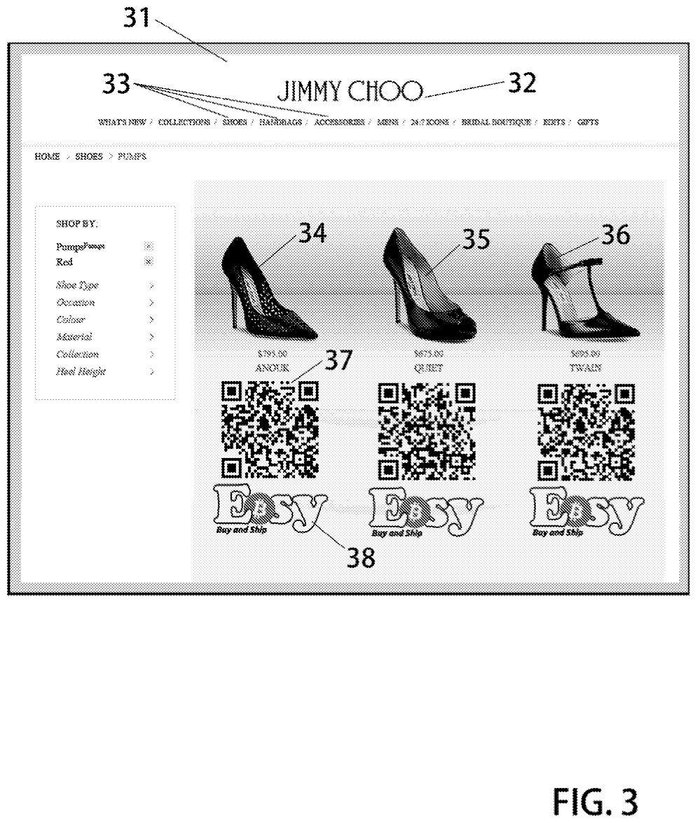

Because systems first detailed in this invention disclosure efficiently provide for both payment and shipping, it is a perfect system to fully displace the shopping cart one-commerce websites. To illustrate a shopping can-less e-commerce site with instant checkout functionality consider the drawing of FIG. 3 which presents a webpage shopping site 31.

The popular ladies' shoes brand ‘Jimmy Cho’ 32 enjoys considerable sale volume via their website stores or ‘e-commerce’ site. However, total sales are constrained and limited by ease-cf-use factors as shoppers tend to quickly tire of tedious checkout processes common to such sites. Indeed important studies have shown increase in sales where impulse type buying is further enabled. There is a certain ‘shopping thrill’ in pressing one button and all is done in an instant. No second thoughts. No backing out. Buy. Receive Easy.

On a typical shopping website a customer navigates via a tab strip web control having thereon choices 33 such as ‘shoes’, ‘handbags’, and ‘accessories’. A product offering page comprises an array of discrete shoe products in a red color including: ‘ANOUK’ 34; ‘QUIET’ 35; and ‘TWAIN’ 36. In proximity to (beneath) each product image, a tag device embodied as a QR code 37 and service mark logo 38 may be displayed to indicate to customers that they may use their special-purpose cryptocurrency client to effect an instant ‘buy and ship’ retail sale transaction. That is, the buyer's computing platform must be initialized with a cryptocurrency client which supports the protocol proposed herein and it will perform cryptocurrency transactions having the buyer's delivery address encoded therein and send these special transactions into the peer-to-peer network.

Presently, common cryptocurrency clients have no provision whatever for encoding the bitcoin (or other cryptocurrency) transactions in this way. Indeed, common cryptocurrency clients available today have no information whatever with regard to a user's postal, mailing, or other delivery address. As such, those cryptocurrency clients are wholly inoperable for use with these systems which depend upon cryptocurrency clients having special enablements.

However, where a user upgrades her cryptocurrency client to include one in which the user's address is maintained as part of a user profile, that cryptocurrency client is in good state to operate in conjunction with advanced cart-less e-commerce sites.

However such cryptocurrency client further needs to be enabled with a module which operates to form these special cryptocurrency transaction specifications in conformance with a specified cryptocurrency protocol and encode therein delivery instructions. Still further, to transmit these special cryptocurrency transaction specifications having a delivery address encoded therein into the peer-to-peer network where they are processed and added to the blockchain.

Once these special transactions appear on the blockchain with validity, Jimmy Choo can be fully assured that payment has been well-received and there is no possibility for chargeback fraud. Because of the high level of certainty, Jimmy Choo can confidently ship product the instant validity is confirmed in this way. Jimmy Choo, by way of a shipping facility administration computer—parses the blockchain transaction record to extract encoded or encrypted delivery information including delivery address and delivery service type among other things. For example, the data payload field OP_RETURN <data> may be passed to a decryption module where the private key of Jimmy Choo is used to decode and finally reveal the delivery address in clear form associated with the buyer. Such encryption assures the delivery address is the true address transmitted by the actual buyer. With this decrypted delivery address, Jimmy Choo can use private courier or common postal services to deliver the purchased product to the very happy customer.

Jimmy Choo can further know which product to ship by several alternative means. For example, each product may have its own distinct cryptocurrency address key which indicates to the Jimmy Choo shipping administrator which shoe the customer has selected. Alternatively, the a product ID specification may also be encoded into the QR code. In this fashion, a user may perform wonderfully satisfying impulse buying with great ease on websites where the traditional cumbersome shopping cart has been eliminated.

Another very important feature of web based versions of these systems relates to tags which are dynamically responsive to web control objects on the same website/webpage. A tag comprising a QR code is coupled to a particular product offered for sale by a retailer as the tag is in proximity to an image of the product on a graphical representation of the webpage. The tag includes a QR code and optionally a label or a logo indicating its membership in a prescribed scheme having advanced functionality. In this version, the QR code state (e.g. optical pattern) is not static, but rather dynamic and responsive to the states of related web controls to which it is bound. When the states of those web controls are changed, i.e. by way of user selections, then the states of the QR code similarly updates to reflect those user selections.

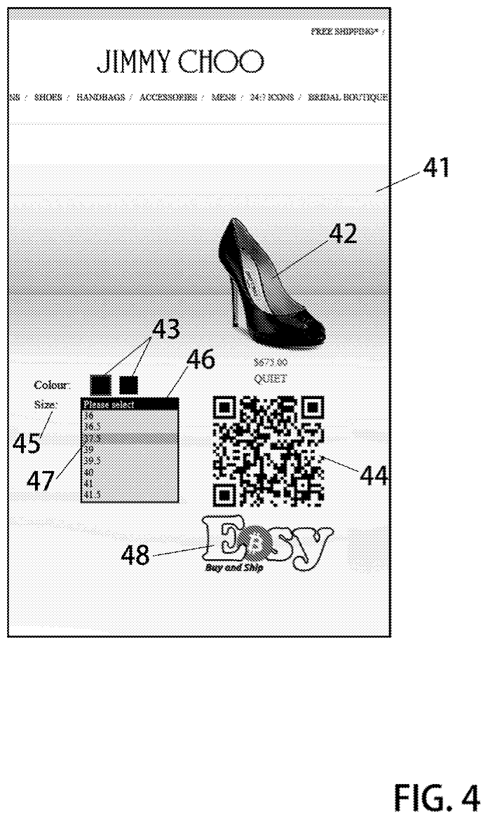

These versions of e-commerce systems are particularly useful where customer choices for certain products are to be specified in advance of purchase. In the example developed previously where shoe sales are taken up on a website, specification of certain user option choices are sometimes required to best satisfy a sale transaction. To illustrate, the attentive reader will consider the drawing of FIG. 4 which shows a portion of an e-commerce type retail sales website 41 in which special web control objects are arranged as graphical user interface elements operable to receive and hold user choices made by point-and-click tactile actions for example. Further, these web control objects are bound to the QR code whereby the instantaneous state of the web controls are reflected in the optical pattern encodings of the QR code.

A woman's shoe 42 comes in two color choices red or black. Color swath sample web control 43 permits users to click on either color to specify a selection. If the present state of the control is ‘black’ and a user clicks on the graphical interface in the red swath thus changing the state of the web control, code behind programming detects the event (control state change) and responds by adjusting the alphanumeric string expressed by the QR code to include that color selection/specification. The optical pattern of the QR code 44 is updated to assure that the new alphanumeric sting is correctly encoded.

Similarly shoe size 45 may also be specified by point-and-click interactions with a drop-down type list box 46. Size choices presented in a list permit users to easily select their sizes from a list of available sizes. By performing point-and-click actions in conjunction with the graphical user interface web control, its state may be set to a ‘size equals 37.5’ selection. When the state of the drop-down list box changes, so does the optical pattern of the QR code to reflect the value selected 47 in the web control. When the optical pattern of the QR code in the diagram is decoded, it yields the following alphanumeric string:

### BA=IEasytRSiWTgz5miX6JraQwciZeQSbPuAR&P=4.75&PID=44758&CLR=Red&SZ=37.S&EB=1

This string is comprised of the following parametric values:

| Name | Label | Value |
|---|---|---|
| Public Key Address | BA= | 1EasytRSiWTgz5miX6JraQwciZeQSbPuAR |
| Price | P= | 4.75 |
| Product ID | PIO= | 44758 |
| Color | CLR= | Red |
| Size | SZ= | 37.5 |
| EasyBuy | EB= | 1 |

These data perfectly specify important elements of the sale transaction. When a cryptocurrency client of these systems decodes the QR code device to receive these parameters, it is well-positioned to form the necessary cryptocurrency transaction specification. In addition to information received by the QR code, a cryptocurrency client of these systems recalls from memory and/or user profile a user's prescribed delivery address and preferences.

These information elements together for basis for forming a cryptocurrency transaction specification in agreement with the selected protocol such as the bitcoin protocol.

To form a complete and valid transaction which operates to cause red Jimmy Choo shoes of the type ‘Quiet’ in size 37.5 to be automatically delivered to the buyer's house, the cryptocurrency client must: 1) be coupled to an established and well-funded cryptocurrency address, 2) recall delivery address information from memory; and 3) parse the alphanumeric string. In possession of each type of these information elements, the cryptocurrency client is able to assemble a well formed cryptocurrency transaction specification and convey that into the peer-to-peer cryptocurrency network.

The web control objects described in the example developed above are formally characterized as an article of manufacture. That is, a computing platform including encoded logic arranged to invoke and bring forth objects which can be expressed as a graphical user interface are articles of manufacture. These may be expressed physically as a carrier wave signal which stimulates a display device into producing a graphical field and further coupled peripheries such as mouse and keyboard to which these objects may be responsive.

These articles of manufacture characterized as web control objects are arranged to express optical patterns which encode data that may be convey by transmission of an optical field pattern or optical wave front. In some best versions, data is preferably expressed alphanumeric strings.

In versions having advanced functionality, these web control object are logically bound to states of coupled web control objects. Web control objects such as ‘dropdown listbox’, ‘combobox’, ‘color selector’, ‘slider button’, ‘radio button’, and ‘checkbox list’ among others may be used to drive the nature and state of the optical pattern and alphanumeric string it encodes.

In best versions, this alphanumeric string includes the cryptocurrency address of the retailer who present the device on a e-commerce website.

The examples above are directed to specific embodiments which illustrate preferred versions of devices and methods of these inventions. In the interests of completeness, a more general description of devices and the elements of which they are comprised as well as methods and the steps of which they are comprised is presented here following.

New cryptocurrency-based commerce systems are proposed here following. In general, devices which may be expressed in a webpage are arranged to present commercial product offers in conjunction with instant purchase functionality. In particular, these devices carry prescribed information which may be used to form purchase orders including product specification, payment details and shipping information, said purchase orders being embodied as a cryptocurrency transaction integrated with a blockchain ledger.

Schemes may be additionally arranged to encode product and product configuration choices. In some best versions, these schemes are arranged about a cryptocurrency address system. Payments are made via a conventional cryptocurrency conveyance in the sale amount as specified in these devices. These special purchase orders are arranged to carry therein consumer shipping data including shipping addresses and optionally shipping preferences.

Purchase orders in the form of a cryptocurrency transaction may be arranged and formed at a consumer's computing platform and transmitted as cryptocurrency transactions into distributed peer-to-peer networks. In striking contrast to systems of the art, these systems do not require any direct communication between consumers and merchants. Rather, consumers who make these special-purpose cryptocurrency transactions by way of these devices and further cause those transactions to be processed at a peer-to-peer cryptocurrency network, implicitly convey purchase orders to merchants as these orders are published on the blockchain. Merchants who deploy these systems monitor the public blockchain to detect arrival of such purchase orders thereon in connection with prescribed addresses known to them.

When transactions in agreement with the teachings are incorporated as a transaction on the blockchain, merchants are moved into action to fulfill the order. Merchants having a special-purpose blockchain monitor detect arrival of these purchase orders as they arrive from time-to-time. Upon such detection of these special purpose cryptocurrency transactions, they are parsed and decoded to reveal product choices and shipping information. Merchants fulfill such orders made by consumers via the blockchain by dispatching appropriate products and goods via courier services to the shipping addresses gleaned directly from the blockchain. Payment is received simultaneously with the purchase order as a cryptocurrency denominated value in an prescribed amount as conveyed from a consumer's possession to an address controlled by the merchant.

The present teaching is particularly directed to devices, methods and articles of manufacture arranged as web control systems operable for bringing about special purpose cryptocurrency transactions that operate as fully qualified purchase orders for deliverable commercial products. Specifically, a web control is configured to carry a product specification scheme. In some preferred versions, products and product configurations are associated by merchants with encodings used in the web control, for example specific Bitcoin addresses are associated with specified products and product configurations. In addition to product specification encodings which operate as unique identifiers to products and product configurations, product specification such as product descriptions in both text and images are provided to be expressed in a fashion which may be consumed visually by viewers of web pages which carry these web control devices. Further, these web controls are arranged to carry price specifications. Price may be set forth as a discrete numeric value and included as a parametric setting of a web control for example.

Optionally, some versions of these systems include an encryption key. In preferred versions, the encryption key is particular to the offering merchant. The encryption key may be used at the consumer computing platform in the preparation of these special cryptocurrency transactions and specifically to encrypt consumer shipping address information.

Apparatus of these systems may be encoded in conventional web protocols (e.g. HTML) and transmitted by http whereby they may be expressed as a web component of a webpage or website of a plurality of web pages. In some versions, additional functionality is realized including script which may be executed on client-side systems such as a locally installed Java engine to bring about dynamic actions in a user Internet browser where they may be expressed. Since it is a primary feature to provide these devices as autonomous systems with no direct communications links between consumer browsers and merchant e-commerce server systems, the cryptocurrency transactions must carry all required information therein and dynamic interactions must be made solely via client-side script execution rather than server-side execution with webpage view state updates.

In one first illustrative version, a device may be fashioned as a highly static HTML only version (i.e. no script). An HTML container such as <div> or <iframe> type HTML element may be used to define a spatial area of a webpage in which the user interface of these devices may be deployed. The device may include a text and image description of a product offered for sale. In addition, a hyperlink web control object may have its ‘Navigate URL’ or a <a href=″″></a> attribute set to a Bitcoin URI. When the hyperlink is clicked, the Bitcoin URI causes a local Bitcoin wallet system (on the consumer's computing platform) to be instantiated and populated with data specified in the URI. For example price and merchant address may be passed as parametric data to a Bitcoin wallet or other Bitcoin engine by way of the URI. The Bitcoin wallet operates to form a particular cryptocurrency transactions by recalling a consumer shipping address from a memory register, abbreviating it, encrypting it, and inserting it as a data payload within the cryptocurrency transaction and finally conveying the transaction into the peer-to-peer network for execution there. All this is done without even a single line of script execution on the client side. A pure hyperlink with well-prepared URI is sufficient in most basic versions.

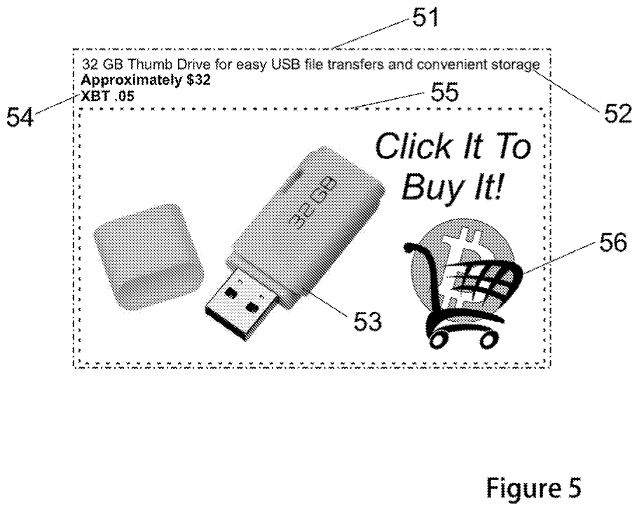

An illustrative example of a most simple device of these systems is presented in FIG. 5. A visual representation of a web control 51 in conformance with this teaching includes a spatial field within which a text description 52 of a commercial product offer sets forth details of the product for sale. An image description 53 may be arranged as a photograph or plurality of photographs to show how a product on offer appears A sale price offer 54 may be specified in one or more currency denominations. An image field 55 is delineated by the dotted line which may include purchase instructions “Click It To Buy It!” as well as a recognized trademark 56 to remind consumers of the available instant purchase functionality. In this simplistic version, the image field may have associated therewith an HTML tag as follows: “<a href=”[URL]“><img src=[URL]></img></a>” which includes the image therewith. As such, any click within the image field invokes the URL specified in the HREF specification i.e. the Bitcoin URI. The following HTML code illustrates one example encoding which may operate to bring about the functionality described.

<!DOCTYPE html PUBLIC “-//W3C//DTD XHTML 1.0 Transitional//EN”
“http://www.w3.org/TR/xhtrnll/ DTD /xhtmll- transitional.dtd”>
<html zmlns =“http://www.w3.org/ 1999/zhtml”>
<head>

<title>Bitcoin Single-Click Advertisement </title>

</head>

<body>

<div id=“ThumbDri eAdvertisement”

style=“width: 450px; height: 280px; ”>

32 GB Thumb Drive for easy USB file transfers and

convenient storage<br />

<b>Approximately $32<br /> XBT .05</b>
<a

href=“bitcoin:132GBBuJi2sxAKCNhn9JtqYDhkoXbLz7PT?EB=1&amount=.05&
Key=72Fio¹@”>

<img

src=“http://easybitcoin.us/images/memory32GB.gif” /></a>

</div>

</body>

</html>

An HTML encoding of a most simple static version of these apparatus

When the image field is clicked the Bitcoin URI

bitcoin:132GBBuJi2sxAKCNhn9JtqYDhkoXblz7PT?EB=1&amount=0.05&Key=72 Fio!@

causes a locally (consumer's computing platform) registered Bitcoin wallet to receive the price parameter 05, the key parameter 72Fio!@ and the Bitcoinaddress

### 132GBBuJi2sxAKCNhn9JtqYDhkoXblz7PT.

The enabled Bitcoin wallet recalls from a memory register having therein prepared user data including shipping address and shipping preferences. With this information a Bitcoin transaction is formed and propagated into the peer-to-peer network for confirmation therein.

A merchant responsible for placing the advertisement described monitors the Bitcoin blockchain. Once a payment arrives on the specified address, address specified in the Bitcoin URI the merchant verifies sufficiency of the amount transferred (0.05 XBT) and recovers the encrypted shipping information in the cryptocurrency data payload. Once decrypted, the merchant dispatches by delivery courier goods to the customer's address as found in the cryptocurrency transaction.

In versions having a greater level of functionality, Java or Silverlight or other client-side scripting can be used to permit dynamic web controls which change state in response to user interactions therewith. For example drop-down listboxes may be manipulated by mouse clicks to effect user selections relating to product configurations. Product configuration choices such as size and color options may be selected in a list of available options. Once users make all applicable choices, a purchase trigger may be invoked thus causing a local Bitcoin wallet to be set into the action of forming a cryptocurrency transaction in agreement with the choices made and further transmitting same into the requisite cryptocurrency network. Accordingly, systems including script execution on client-side are additionally anticipated where the application demands further functionality such as user selections related to product configurations as well as other dynamic functions brought about by various forms of script execution.

A primary function of these systems includes forming special cryptocurrency transactions which carry customer shipping information within the transaction. When a device of these systems is provided as part of a webpage, users wanting to make a product purchase may click a purchase trigger such as a command button type web control. In response to stimulation of such purchase trigger, a user's shipping address specification is recalled from a memory register. The shipping address specification is sometimes manipulated to better fit into preferred data payload schemes having limited form and size in agreement with various cryptocurrency protocols. In some versions, shipping address specifications may be abbreviated to consume less bandwidth. In addition, some high performance versions benefit by obfuscation or encryption of shipping addresses included in within these special cryptocurrency transactions. As such, a step characterized as ‘forming a cryptocurrency transaction’ can include recalling and preparing a shipping address and inserting that into the cryptocurrency transactions as the special-purpose data payload. So formed, cryptocurrency transactions including a consumer's shipping address are conveyed to a network as a well-formed transaction in conformance with the protocols defined herein. Transactions received by processing nodes are accepted for integration with the blockchain for example by miners arranged to process Bitcoin transactions.

Therefore, certain methods of these systems include the steps as follows: detection of a trip even at a purchase trigger; recalling a shipping address specification from a memory register; forming a cryptocurrency transaction in conformance with standard cryptocurrency protocols, and transmitting such cryptocurrency transactions to at least one peer node of a distributed network.

Some methods also may include a step of displaying devices described as advertisements or offers of goods and/or products for sale. When taken together, these steps effect a ‘Buy Now’ instant purchase functionality whereby web control advertisements presented within webpages enable single-click purchases to be made by consumers who can expect automated delivery to their home via next day express courier service for example.

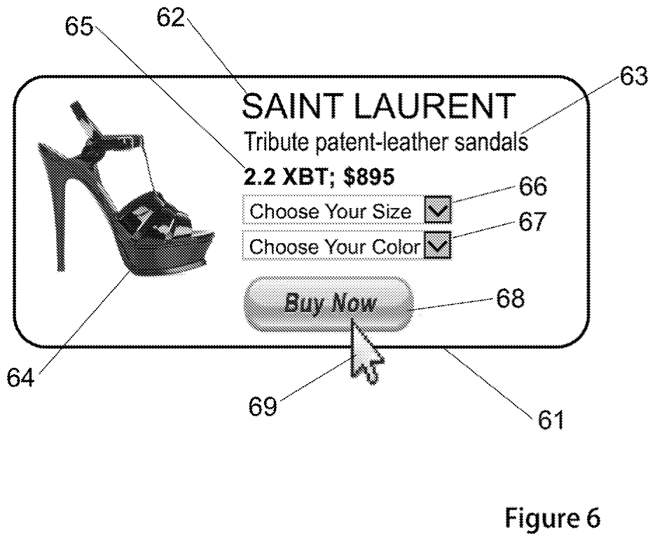

For a more complete understanding, illustrative examples have been designed with diagrams having references to the following text FIG. 6 shows an important illustrative web control device of these teachings.

An example version of devices of these systems having special function is provided as a line drawing representation of a user interface or web control advertisement. In conformance with this teaching, a mouse click or other stimulus with respect to a command button or ‘Buy Now’ purchase trigger causes execution of code in a program module or so called ‘code behind or other associated stored program code to bring about a cryptocurrency transaction and further cause same to be conveyed to a peer-to-peer cryptocurrency network. An e-commerce product offering is fashioned as a user interface advertisement 61 responsive to customer interactions such as mouse clicks. Because these systems are distinctly arranged with a particular item for sale, rather than a general promotion of a fashion brand for example, it is necessary to provide a detailed description and specification of the particular product which is to be subject of the sale transaction.

A product offered for commercial sale from YIves Saint Laurent company 62 includes a text description and other specification which relates to the particular model of shoes available for purchase. A text description is provided as a user interface label type object 63. The product being offered for sale is further defined by the image and/or photograph 64.

It is very important to notice that these advertisements may be served by a third party website not operated by Yves Saint Laurent (manufacture) nor by the actual contracting party the web merchant, but rather by a third party web host which may operate the web controls in conjunction with the merchant who promises to effect fulfillment.

A price specification may also be presented visually as a label type web control for example setting forth the amount a user must pay to purchase the advertised product—i.e. ‘Tribute patent leather sandals’. In this example, the advertisement sets forth price in two denominations including one in fiat units or ‘USD’ and one in cryptocurrency units or ‘Bitcoin’ whose symbol is sometimes and herein written as ‘XBT’ To purchase these shoes via this advertisement and purchase platform, a customer will be required to pay 2.2 Bitcoin. As these systems are wholly inoperative for transmitting fiat currency, it is a necessity to provide price specification denominated in Bitcoin or other similar cryptocurrency unit at least with respect to the‘backend’ of the system, that is the payment transfer rails.

In some versions of the se advertisement platform systems, prices are displayed in only one denomination (i.e. either fiat or cryptocurrency) However, where fiat is specified in the advertisement, a conversion is necessarily made to arrive at an equivalent cryptocurrency value prior to transmission of the transaction. The end result of executing a purchase action via the system is a cryptocurrency transaction which necessarily demands discrete value specification in cryptocurrency units. An exchange rate (either dynamically retrieved from the Internet in real time or a prescribed preset rate) may be used to convert values specified in fiat units to an equivalent value in cryptocurrency.

Special versions of these commercial purchase devices provide for product variances. While the advertisement illustrated puts forth a single model of shoe, customers prefer to select product (i.e. shoe) configurations such as size and color. Accordingly, these e-commerce purchase devices are sometimes arranged to accommodate product variant selections by way of easy-to-use interface which includes a dropdown listbox type web controls 66 having a plurality of size selection values, and cooperating dropdown listbox 67 which includes a plurality of color selections.

By clicking on the dropdown listbox web control object, consumers select the size and color from the plurality of available choices. After setting the states of these web controls, a consumer may commit to the purchase by clicking the ‘Buy Now’ purchase trigger or command button 68. A cursor 69 placed over the button simultaneous with a mouse click trips the button to invoke an ‘event’ code module associated with the web control. Specifically a‘click event’ may be handled by a code module to be executed whenever a mouse click/cursor over combination occurs with regard to the button. The code module may direct actions taken by a local computing platform on which the web control is running (for example in a web browser).

Web control systems such as the one illustrated as FIG. 6 are provided as digital encodings in agreement with one or more protocols for example HTML and script languages such as Java, JavaScript, .Net, Silverlight, php et cetera. A static definition comprising a plurality of sometimes nested elements and script set forth both visual appearance and performance of these web control systems.

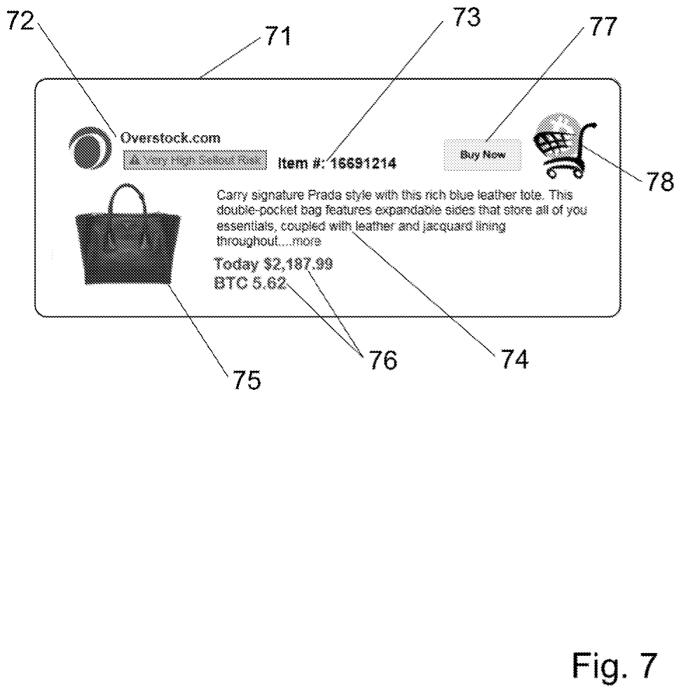

Another important illustrative example of a commercial advertisement web control device of these systems is presented as the diagram of FIG. 7. A web control 71 is visually depicted having a merchant vendor identified via branding lo go 72. A specific SKU for product ‘Item #’ 73 is set forth to indicate precisely the product being offered for sale. A text label type web control 74 is a written description of features of a Prada handbag. Photographic image 75 is also part of a description to inform consumers of the nature of products offered for commercial sale. The price in two denominations is presented as text label(s) 76. A purchase trigger 77 is fashioned as a single-click ‘Buy Now’ command button type web control. Service branding logo 78 indicates to customers familiar with the special ‘Buy Now’ with automated shipping service the availability or enablement of such instant purchase functionality. Consumers having an enabled local Bitcoin wallet prepared with a prescribed user profile registry in which a preferred shipping address is specified may click the ‘Buy Now’ button, and nothing more, to cause a cryptocurrency transaction to be formed whereby the consumer's shipping address is therein included, and further to cause the transaction to be conveyed to a peer-to-peer cryptocurrency network where it may be incorporated into a public blockchain. As the cryptocurrency transaction prepared in this way includes a merchant Bitcoin address having been previously associated by the merchant with the product offering in a merchant fulfillment system, a merchant understands payments on this address are intended to be purchase orders for the Prada handbag. So long as the transaction includes payment conveyance in the amount of 5.62 Bitcoin, an amount sufficient to purchase the bag, the merchant can decrypt and expand the consumer's shipping address therein and deliver the product—without exchanging a single byte of direct communication between consumer and merchant computing systems. The only communication between the consumer and merchant is via the Bitcoin transaction accepted into the blockchain by network processing nodes,—a transaction which contains all necessary information regarding product selections, payment, and shipping.

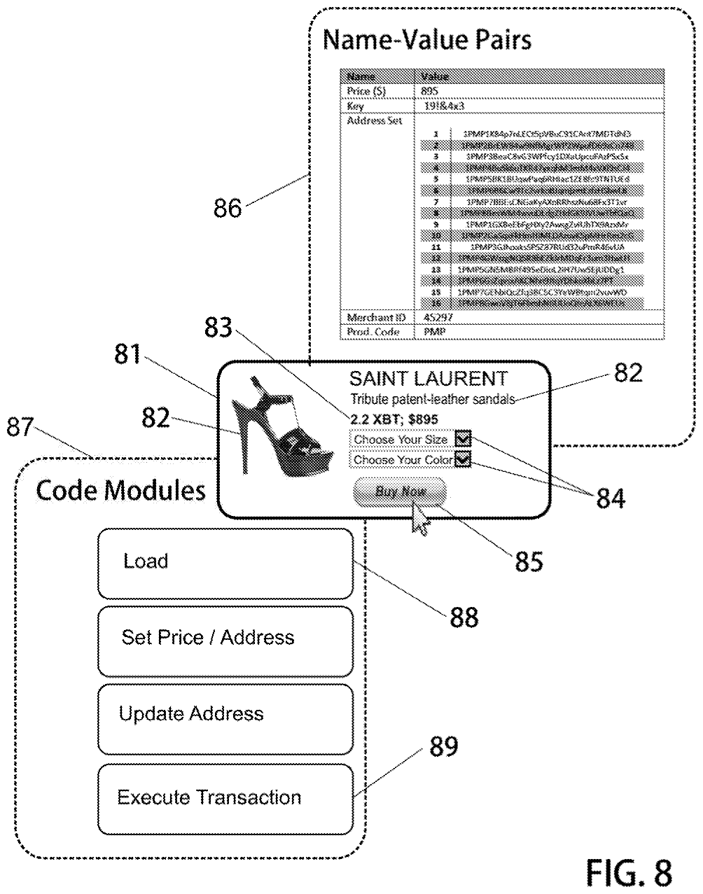

It is important to appreciate that FIGS. 5-7 are merely visual implementations or expressions of those devices and articles. In some preferred versions, devices of these systems are further comprised of preset parametric data arranged as name-value pairs for example and a collection of executable code modules. Accordingly FIG. 8 is an illustration provided to give further definition to devices with particular attention to the non-visual elements of these apparatus.

A web control device 81 is provided as a product offering and advertisement having special single-click instant purchase functionality, i.e. a built-in complete checkout function. A product offered for commercial sale is described by image and text fields 82. A dynamic price label 83 includes price specified in two denominations including dollars and bitcoin. In this example version, the single value amount in dollars is fixed at $895 and the amount in bitcoin 2.2 is calculated from an instantaneous exchange rate. At the moment the device is instantiated, for example during a ‘load’ event code execution, a fetch call is made to an exchange rate provider to get an updated exchange rate value in view of current open market trading activity. The amount $895 is multiplied by the instantaneous exchange rate to arrive at a present bitcoin value of 2.2XBT Should the same device be loaded at a later time, one can expect the exchange rate to have changed and the corresponding amount of bitcoin will likely be an amount different than 2.2XBT. As such, the label is modified to present the current value in bitcoin.

After the device is fully loaded, the controls such as dropdown type listboxes 84 expose an interface by which users may easily manipulate states thereof to effect selections. For example a dropdown listbox may be provided to permit users to make a size selection. Shoes are a special product in that an identical model of shoe is often available in various sizes. Unlike handbags which typically only come in one single size, it is necessary for customers to specify which shoe size is desired when purchasing shoes. Similarly, a single model of shoe may be available in a plurality of colors. As such, it is useful for consumers to be able to select a preferred color from a list of selections. Finally, a purchase trigger 85 is provided as a command button that is responsive to single-click events thereon.

While copies of template versions of these web controls may exist without variation, these web control devices must be initialized prior to deployment as commercial platforms specific to certain goods to become fully operable. Specifically, a template control device must be initialized with parametric data sometimes set forth as a collection of name value pairs 86. Price may be set forth as a numeric value for example. Since price varies depending upon the specific product being offered for sale, each web control device is distinct from others as the price (and sometimes other factors) must be set prior to deployment.

In some high-security versions, an encryption key is used to protect shipping data. These may be assigned to authorized merchants such that only they can decrypt orders made for their goods. In some versions of these systems, a web control provides a key to the local bitcoin engine which uses the key in an encryption operation prior to transmitting the transaction to the distributed network.

At least one of Bitcoin address provided by a merchant administrator is necessarily specified. However due to the nature of Bitcoin addressing, each merchant must maintain privately his own addresses and addresses are not shared between merchants. Therefore, merchants must set an address or address scheme and so provided addresses must be specified when these controls are initialized prior to use. In some preferred versions, merchants establish one-to-one associations between addresses and product configurations and these are specified as an address set in the parametric data of the control.

Other important ancillary data may be also associated with the control and this data may be used by the local (consumer side computing platform) to alter performance or execution of these transactions. In addition to initialization data, these web control devices also include prescribed program logic 87 which operates to bring about functionality described.

For example, a web control ‘load’ module 88 may be called upon first invocation when a webpage which includes the control is being expressed in a web browser. The ‘load’ event may be used as described previously to get information such as an exchange rate which depends upon the instant when the control is being expressed. Additional program code or logic is executed in accordance with various events which can occur during expression of the device. For example, when the state of a dropdown listbox is changed an update to a selected address may be made to reflect the user selection in the Bitcoin address to be used for the transaction.

Finally, a logic module 89 is provided to handle the purchase trigger trip whereby all data is assembled and used to form the requisite transaction and send it to the cryptocurrency network. A ‘clean-up’ module may be used to terminate the control with dignity and for example close any communications connections opened during the life of the device. Although not shown in the diagram, it is to be understood that many code modules might be arranged to support additional related functionality and response of these devices. Without deviation from the essence and spirit of the invention, various versions may be arranged with particular supplemental functions.

In some preferred versions of these systems an apparatus and device is provided as a web control element suitable for expression in a webpage via web browser interpretation of an HTML encoding. A web control apparatus 91 may include a set of sub controls 92 such label type web controls, command button type web controls, dropdown listbox type web controls, among others.

To provide for functionality of the web control apparatus and all included sub controls, a collection of modules of executable program code are associated therewith as appropriate. When ‘events’ are declared by the host computer and/or web browser in which these devices are being expressed, these code modules may be selectively executed A prescribed set of data 94 may be prepared with specific values and content which further establishes these apparatus as operable for the purposes in which they served. For example, where the device operates to offer a product for sale a sale price 95 may be specified as numeric value. A price specification may also be arranged as a two-part specification where one part ‘floats’ in relation to the other by way of a dynamic multiplier which changes in time. In all cases these apparatus include clear means of setting an instantaneous price specification with respect to a discrete product being offered for sale.

An address or address set 96 may also be stored as a string constant value, for example a 26-34 character alphanumeric string forms a Bitcoin address and this may be set by a merchant who arranges a web control device in conformance with this teaching. A particular matter of importance relates to an association between a particular address and a product being offered. In some best versions, there is a correspondence between a Bitcoin address and a product being offered for sale by way of a web control. As such, this association is maintained by the merchant after the device is deployed whereby the merchant can receive payments on such prescribed address and implicitly understand which products are being purchased. While it is entirely possible to set forth product selections in alternative part of a Bitcoin transact ion, some preferred versions enable product specification by way of choice Bitcoin addressor addresses.

Web control apparatus of these systems further include product descriptions 97 which are embodied as text and image data presented as part of a web control device. Text description 98 may be prepared to inform a potential customer of details relating to products being offered. Photographic descript ion 99 may also be included as prescribed data of which a web control is comprised.

Further, some special versions of these web control apparatus include a logo 910 or icon device to indicate to users the presence of a single-click Bitcoin purchase functionality. Familiarity with a recognized trademark allows experienced users to understand that these devices are associated with underlying function which permits instant Bitcoin purchases with automated shipping. In this way, advertisements fashioned as a web control apparatus described can be marked with a trademarked logo to impart immediate recognition of the performance which experienced customers will come to expect and enjoy.

Web control elements or sub controls from which these devices are comprised include in particular a purchase trigger control 911. A purchase trigger may be established to respond to mouse clicks thereon and in particular to cause to be transmitted into a cryptocurrency network a transaction having therein a shipping address specification. In best versions a single-click on a purchase trigger control results in conveyance of a fully qualified commercial purchase order formed as a Bitcoin transaction including therein a payment for a prescribed specified amount, a product selection generally made by way of the particular Bitcoin address used, and finally a shipping address on which a consumer prefers to receive courier deliveries of goods.

Additional sub controls from which these devices may be comprised include but are not limited to selection means 912. Web controls may be arranged to provide user interface whereby the control state may be easily manipulated by users to effect product configuration selections such size and color choices for example. These controls may be fashioned as a dropdown type listboxes, checkboxes, radio buttons, et cetera.

Some static web controls may be fashioned as label type web control elements and image type web control containers 913. Text may be presented to describe product offers and such descriptions may be additionally augmented by photograph or other image data which might be presented along therewith in an image type web control container.

These web control apparatus are specifically comprised of a plurality of executable code modules 914 arranged to control functionality of the device and its subparts. Code associated with various elements, may be executed in response to event declarations which may occur as the web control is being expressed or otherwise presented as part of a webpage. For example, when a consumer selecting a size from a list of choices in a drop-down type list box, a code model responsive to changes in the state of the dropdown listbox may operate to change a current or ‘selected’ Bitcoin address from a plurality of prescribed addresses. The selected address having at the merchant a previously established association with the size choice, the merchant is implicitly informed which product size to ship.

Finally, in some versions web control apparatus additionally include some that parameters which operate to specify visual settings 915. For example, a cascading style sheet rule 916 or a formatting definition 917 may be provided to control the appearance of the device when expressed as part of a webpage in a web browser.

While embodiments of these inventions presented as apparatus are most readily understood by even casual readers, the inventions also include methods to bring about commercial purchases by way of a cryptocurrency blockchain. Specifically, a method of making a purchase order 101 includes a plurality of steps which may be characterized as detecting a trigger trip and in response thereto forming a cryptocurrency transaction with a customer shipping address recalled from memory and transmitting said transaction into a peer-to-peer cryptocurrency network.

In a first step 102 of these methods, a purchase trigger is activated or tripped by a consumer intending to make a purchase of goods for delivery to a default address. A consumer viewing a webpage having expressed therein a device of this teaching may ‘click’ on a hyperlink object or other web control device to set into motion the following steps. In a subsequent step, a delivery address specification is recalled 103 from a memory register. In particular, a Bitcoin wallet or other Bitcoin engine arranged to provide Bitcoin related services has a memory register or access to a memory register in which a user has previously prepared and set a default delivery address specification. This information is recalled and used in formation of a cryptocurrency transaction 104 to be sent to peer nodes of the network. In some method versions, an address is manipulated from a clear text form to an abbreviated form to preserve bandwidth of a Bitcoin transaction data payload. Still further, in some versions address specification in clear form or abbreviated clear form are obfuscated or encrypted to protect from unauthorized uses. However, in all methods a customer shipping address is integrated in some form within a cryptocurrency transaction to be coupled with the blockchain.

With the parameters including the sale price, the merchant's cryptocurrency public-key or address, the customer's shipping address, a cryptocurrency transaction which operates as a purchase order is formed in agreement with protocols described herein. Because a merchant anticipates receipt of payment on addresses known to it, a merchant facility is set up to ‘listen’ for arrival of so formed transactions on the blockchain and it is to be understood that these transactions operate as purchase orders whereby delivery to the included address is implicitly expected.

The final step of the method includes transmitting the transaction 105 to a peer-to-peer network where it may be processed in agreement with rules set forth there and be included in the blockchain in due course.

While one can readily appreciate that the invention includes apparatus and method as described in detail here proceeding, it may not be as easy to appreciate that the systems also include an important physical construct that is a special electronic or electromagnetic signal which is encoded or otherwise modulated to impart the nature and function of these systems. A carrier wave signal is an article of manufacture 111 generated by forming an electronic signal for example, the electronic signal having a digital modulation which can drive coupled electronic systems into particular actions and responses. Articles of manufacture of these inventions include the following four primary elements.

A portion of the carrier wave signal is encoded as a purchase trigger. A purchase trigger 112 causes a coupled computer logic processor to be responsive to user input whereby a trip action with respect to the trigger results in execution of coupled code to effect the generation of a special cryptocurrency transaction in which a shipping address is included.

A portion of the carrier wave signal is encoded as a cryptocurrency address 113 were address that whereby the address or addresses have been apriori associated with a particular product or product configuration by a merchant administrator. Another portion of the signal is encoded to carry information as a price specification 114 or single numeric value to be used in a cryptocurrency transaction as a value to be transferred from a consumer to a receiving merchant.

In consideration for products subject to the purchase order plus any applicable fees taxes commissions and other charges.

Finally, carrier wave signals of the systems additionally include a specification of products 115 and/or product configurations. These may include encodings of text descriptions and image encodings for example bitmapped images.

While certain best modes anticipate deployment of these systems about an advertisement construct, other important modes operate with schemes which are not strictly an arrangement for commercial advertisement. Indeed, certain user interface systems are arranged to provide information where the primary purpose is not specifically sales but rather in support of general curiosity and interest. Such user interfaces not arranged for advertising may nevertheless carry therewithin a commercial sales function. One clear example of this can be studied in view of the very popular social media website Pinterest. The Pinterest website includes user boards to which various items, topics, subjects of interest, may be associated. In some cases, these items may be items readily available for commercial purchase. In such cases, the user interfaces used to present information about these items may include links to sales channels, e-tailers, web commerce sites, or more importantly instant purchase functionality in accordance with teachings first presented herein. In particular, a purchase system which permits Bitcoin (or other cryptocurrency goes parenthesis users to convey a transaction into a peer-to-peer network whereby the transaction carries payment and shipping information.

In an important illustrative example of certain embodiments of these systems. FIG. 8 shows a common social media website integration. This version is very important as it demonstrates that an entire commerce checkout platform may be deployed with very minimal impact with regard to look and feel of a well-known social media websites such as Pinterest 121. The very familiar user interface including user 122 specific identity information including a profile picture 123 and custom interest board 124 contents includes a commercial product of interest, an ‘alarm ring’ product described via text description 125 and further via image 126.

Viewers of the Pinterest website are offered functionalities quite specific to the operational modes of the Pinterest protocol. For example, users may ‘pin’ the product into one of their boards with the ‘Pin it’ command button 127. Users may attach an approval/disapproval indication word ‘like’ and/or‘unlike’ to a pinned or otherwise marked item. Users may click a Facebook share type command button 128 to integrate the item with Facebook functionality—for example post to a user's timeline therein the Facebook social media website. But most importantly in accordance with teachings presented herein, users may use a ‘Buy Now’ command button 129 to instantly purchase the featured item and receive delivery thereof at a default shipping address previously recorded.

There are at least two ways in which the social media website Pinterest may bring about the described commercial instant purchase functionality. In a first method, the ‘Buy Now’ command button has a hyperlink function with a navigate URL set as a Bitcoin URI having a prescribed merchant Bitcoin address and sale price set forth therein. A local Bitcoin wallet transmits a Bitcoin transaction to the Bitcoin peer-to-peer network blockchain and that transaction carries therein the consumer's shipping address as well as payment for goods being purchased.

Alternatively a user profile and cryptocurrency wallet may be integrated directly within the Pinterest membership schemes. Cryptocurrency on deposit in a user's account may be transmitted to certain specific merchant addresses along with encoded shipping information from the social media membership administration as a common Bitcoin transaction in conformance with the standard protocol—albeit including a special data payload fashioned as an encoded shipping address.

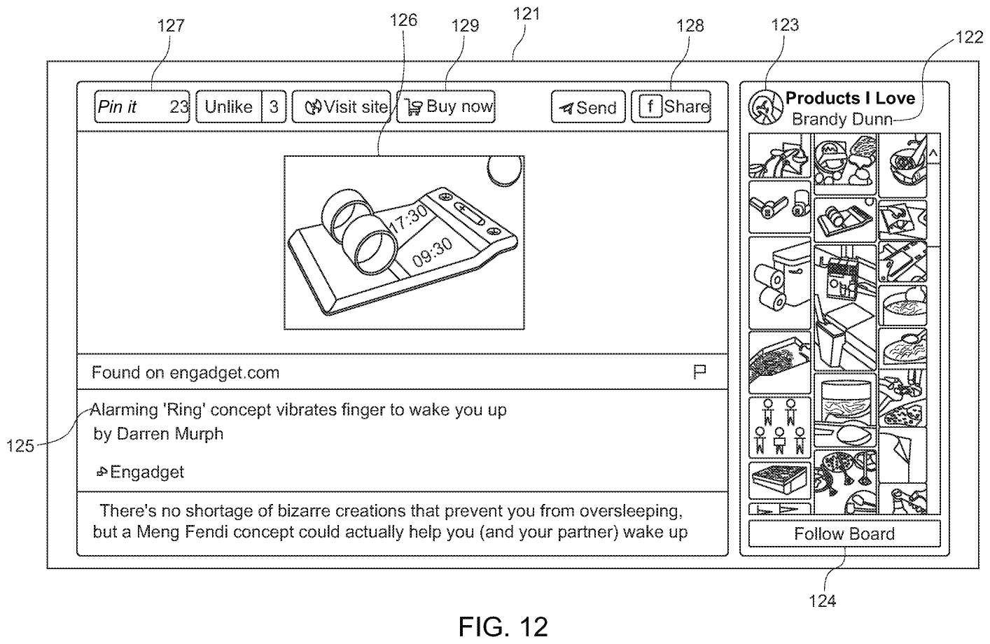

In either case, a consumer purchase is affected from the user interface which is viewed by consumers in a simple everyday web browser without special modification. FIG. 12 is important as it illustrates versions in which a simple command type button is integrated within the already familiar user interfaces deployed as part of the very popular interest platform. It is not necessary to configure highly specialized web controls to enable the commercial platforms taught herein. In most simplified versions, a common hyperlink HTML element having a well arranged URI can serve to fully enable a local Bitcoin wallet to send purchase orders arranged as Bitcoin transactions which fully specify both payment and shipping information.

Another most important user interface and website which supports posting of these apparatus, methods and articles of manufacture is commonly referred to as Facebook.

The Facebook platform is widely used the world over and enjoyed by so many millions of people Despite being an excellent social media platform having exceptional breadth with respect to functionality, Facebook today does not efficiently operate as a commerce platform. This is due primarily to the difficulty of operating a fulfillment center and further is exasperated by the complexity of operating payment systems in the website Facebook remains a limited social media website in which sales of goods cannot readily be effected.

To serve the consumer community, Facebook does operate sophisticated affiliate and/or advertisement and referral services. In a right hand column of the standard user timeline page, Facebook serves select advertisements known to be highly relevant to specific users. However, these advertisements do not perform in a manner whereby users can affect purchase transactions from within the Facebook user interface. Rather, the advertisements carry a complex URL which operates to redirect a user browser to a merchant website where a full checkout facility permits a merchant to receive payment and delivery information. By way of the forwarding URL, a merchant knows a consumer came from the Facebook website and precisely by which advertisements and a great deal of other information. Indeed, the URL of the Facebook advertisement may be very detailed and lengthy as it conveys a considerable amount of information so that Facebook may be properly compensated for sales which might take place off-site. An example of a Facebook URL used in connection with an advertisement to forward customers to an affiliated merchant website is:

https://www.facebook.com/a.php?u=http%3A%2F%2Ftransferwise.com%2F%3Futin_so

urce%3Dfacebook50%26utm_medium%Dpaid_social%26ntm_campaign%3DFREC&_n_=%
2Al&At=3 . AQ KV9E8pRTBllfqKmvBWx-
BbJedVdky_FLi2KPha8FWsOOZlSohUauc6TkePdovMVTVdAW4STAlV91OrFp6Ep A3E6yBl
WvAmG_5go48dyE2-
ecPxxe32bQ89_L2io2dimxXfnAssG7BLp4LGMeeDQMH5qUUiE6Eh5KjlqgCmCcuf_rSxtxlon
yq_9DaoIlNrc8eWTC vjQRM zfEYM9iRU7xxrNdQgGdtFJBN0ScynYqt-
8jf5bvmM1D_TLPLbnd4FVIA VzXt5zgraPL5h-
GfcTO8V9IalkCzHieJ06b_ipdGmphCRoXwRw7NxmHA3-
7DFvSJI8v9JmqEz41_ZZzfe_3JPKyyHAwj nUCRm9YKgoQOuUsPtAI5E2FQ8_QAIBwvsj6o-
NkjYN3WqXDNLqJ-IXrsj6 1kN7juarkcfkNjF74-5madBxhetMinimTZgWaZ A9n-
9H4zHRq3IEG_tK3dPcOYP8hx3rJlpVdA24VoW4UAb86uNpr3alPrw ris2ufFQSVenSKn8tFzkan
m_HebmldnFKSrDu6aPa16Tys4J9OV2fvjaOU0 1 gf3 Xn2HEzT9EEbAJvoXhZHqSnEg5oZAL6
APn3q_wWeeFeD5hf-
MlS33SEnpSSpWe5kERA4D3xBojWz0qmpmW4BqBKghv0IWBzikurLi2ern MU pJvP8tEtR-
jWXI61FcgLK-yJ6W I8ySeR 1 KOkde5GV4uvWr-q5yTS5PAa-XGj7ek6oGdu6GI5vwtaiB4O-
DswLhxUmlcbUa_un0 1 sZ4P6o95ZZ8VrJ flnwJo8nNzYxcM_ r7NeFNKL5aKZB3ZCvKnYiMA
2LhndHIDzbr05dVTqEAITzYUB6XDP17GjhbeLXluly0eLYmwemtq0clgW14_tlpyefly-
GH3NLuRTZvXHeMaVNgxsYDXVg6Nl4nyPnVSZPt8QIILJfQeNiijy7EXeRDqFtEIWGH2P94
3WGjvUptPOvITBagXPO36j,alqtotXpyrljLV_ChzSSV_IdHZIDbiUHgYGrD1DpGJg5nlTYUs
Kog8yhYTQ1MlmSpbvrG9vHspEdv6s9tOKzWABKW72aU3gLIExl4kjlhw3 aM2157frDZqEphr5
kgpGui0RYlKNGbd47s-Hy6W-
xqLLz7lpp8UxkUfs7AgAZDZfc28YxnnCyjsV0aeYdidPnWwL81Gaxbo7pKX5QXjE9kHtlcGY
m3vg-oUYBJMdS9-CEU460lfEWilh-2UHwtnFcc wTNTx-
b8irPeqYg7ItV8NFwwKGkgvnliuzgQm3xC9-IP-
0VdEmuMfdGuMMuKdYRk4RITm_21NPj2aPc9bXViO4UwvnnVFyTIDtplqFl5813ULzZglJtYur
LFjzu53RmkBTY7kPazHY9i5zrcik i_HY5n5 VdyDC4BFYLESXxTMRLUXml7259lW2EZf4Cui
78mJf3PfRq6CtDVYdjadrhynqCNsjwJd8H5Bp8Zu99E-
B pjOKLaEyfOieHJkSniMOIVIKgpi5P7TPeLE rszeuJCumOBqXJROh2iT5Y5hk:3CR19UXpJwb
pkvL9Nj9TAkh2FVZaw6YWf7nv2zNrgRbw_C4TF2r9ktnev-N_m1-
kHikcabKReR1LYT0btvFKKg7ZZTwbJ5LXEK2qGc5N0kdXCw5tyoEK0EI93ZRMYsFqWGko
O-SFWgTG_PTfhRQH3dLOujbcS9W 5NyCoavpmGCMoQEAMZ-ljhOB-
vJ77ztclm6kSWdj39B2DxTsX.5drjrFLJwRQh-
tcV6rRe085OQ3SYzcT_SweLq6a2XPnR0reDYaR8gfNcHnZl8 jnjJZgH2gdGeMWtxThGn4gNv
9mzq3MF6a8-89eleH04zHX34&mac=AQflk0HX_ Ols555&sig=129364

As it is a primary function of these systems to enable social media websites such as Facebook with an improved commerce platform which operates entirely within the host site without browser forwarding, web controls are provided to affect both payment and shipping, i.e. the entire checkout process, in connection with a cryptocurrency networks such as Bitcoin.

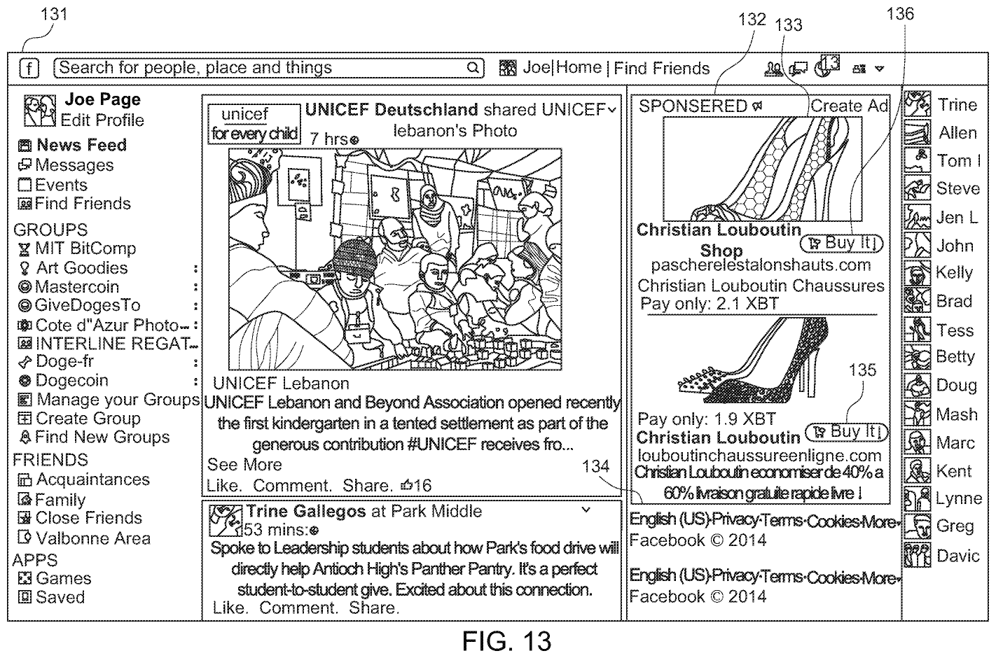

For a more complete understanding, the reader's attention is directed to the illustration of FIG. 13 which depicts a webpage instance for the social media website Facebook 131. A special-purpose column 132 at the right side of the webpage may host therein these special-purpose commerce platforms described in detail herethroughout.

In particular to advertisements 133 and 134 are arranged as commercial offers for luxury shoes. A detailed product description including photographs and pricing informs potential buyers of the product offer. These advertisements each may have an underlying Bitcoin URI with appropriate parameters whereby a single click on purchase trigger 135 or purchase trigger 136 causes the corresponding pair of shoes to be purchased via a Bitcoin transaction which operates as a purchase order. Specifically, a Facebook membership administration module provides a consumer's shipping address to a local Bitcoin engine whereby a transaction for the prescribed amount is conveyed to the prescribed merchant Bitcoin address.

By virtue of the fact that said payment arrives at the blockchain on the address known to the merchant, the merchant regards the transaction as a purchase order for goods. The merchant responds by dispatching goods to the consumer via the shipping address gleaned from the Bitcoin transaction i.e. via a data payload field in which an encrypted shipping address may be carried.

The consumer's web browser does not exit from the social media website—but rather it remains finally coupled to the various webpages from which it is comprised. While a Bitcoin engine does transmit a well configured transaction including an encrypted shipping address, the consumer does not interact in any manner with a merchant website and not a single byte of information directly is conveyed from the consumer to the merchant. Rather, the entire purchase order is represented in the Bitcoin transaction which the merchant discovers on the blockchain and processes in a fulfillment center.

### Address Carries Product Specification

It is convenient in some preferred versions to use Bitcoin addresses to carry product specification information from the consumer to the merchant by way of the blockchain. While in some alternative schemes product specifications can be encoded in other Bitcoin transaction data payload mechanisms, using the Bitcoin address is sometimes a most convenient manner as it mitigates wallet complexities and further eliminates an additional parameter of a URI, conserves bandwidth of Bitcoin transactions, among other reasons. In schemes which used data payloads other than Bitcoin address, it is sometimes necessary to prepare the Bitcoin URI with an additional parameter which is parsed and used by the local Bitcoin wallet to form such data payloads (i.e. so called ‘multi-sig’ schemes, dust payments on pseudo addresses (ala Mastercoin's ‘fake’ address schemes) which carry data, et cetera).

When Bitcoin transaction output addresses are used to encode product specifications, specific choices of product SKU may be implicitly made because specific Bitcoin addresses are a priori associated by merchant system administrators with discrete products and/or product configurations Therefore, some preferred versions use Bitcoin addresses to encode product specification Associations previously established by the merchant between various selected address and product select ions to merchants implicitly. While product specifications by other Bitcoin transaction data payload conveyances are fully anticipated, they do not render unique nor give rise to new invention when such schemes are adopted.

### VanityGen—(Vanity Bitcoin Address Generation)

Because it is possible to produce Bitcoin addresses with a certain subset of chosen characters, in some schemes it is desirable to create particular Bitcoin addresses with specified leading characters for example which might be readily associated with certain products and product configurations A widely used software package commonly known as ‘VanityGen’ permits one to produce a Bitcoin address with up to about 8 chosen characters without great difficulty.

While so called ‘vanity’ Bitcoin addresses have been made with more than 8 specified characters, it become rather difficult computationally to achieve Bitcoin addresses have more chosen characters. However, many useful produce SKU encoding schemes are possible where 8 leading specified characters chosen by a system administrator. For illustration purposes, the following address with the leading characters ‘1uspto’ was created with the VanityGen softwareoutput
C:\Innovi\Downloads\VanityBitcoin\vanitygen-0.20-win>vanitygen641uspto Difficulty 15318045009
Pattern: 1uspto
Address: 1usptocxbPfZFmMkHxaAmNWa6D9oiuc5r
Privkey: 5KBALg7g27DNqN3cDPJXeZHHk9oqwTZ5o8NSJB4w6S92oyrC1Zo

While this is sometimes referred to as an ‘address’, it is actually better characterized as a ‘key pair’. A ‘key pair’ is comprised of a public key and a private key A holder of a private key has signature authority and spending rights for any unspent value stored on a complementary public key or ‘address’.

When a merchant administrator choses a set of products to be sold via these systems, an initialization step may suggest the merchant associate specific addresses with each of the distinct SKUs associated with such products. For ease of identification, some merchants will select addresses having leading characters which can indicate to human operators the identity of the product associated with the address.

### Address Switching to Indicate Product Configurations/Choices

Because preferred versions include advertisements embodied as dynamic web control type objects, it is useful to make product choices selectable by user interfaces such as checkbox type web control devices and drop-down listbox type web control devices. Consumers who receive these advertisements via webpages can directly manipulate web control objects therein. Rather than sending consumer selections to a merchant web server in an interactive scheme which requires two-way communications with a merchant web server, the web control merely manipulates parameters of an associated Bitcoin URI string for example by changing from one Bitcoin address to another address whereby each address is previously associated by the merchant with a distinct product configuration. This function may be executed purely as a client side operation without need to communicate with any remote server.

As it is a fundamental premise of these systems that the advertisements be operative and independent of third-party systems (i.e. merchant servers), product selections and product configuration selections must be conveyed wholly within the cryptocurrency transaction. All information relating to the purchase order must be carried entirely within the Bitcoin transaction so that checkout (transaction specification) is 100% effected within the blockchain transaction. Accordingly when a user chooses a product for purchase, and product configuration/options, those specifications must be incorporated with the Bitcoin transaction.

In a first example scheme where product selection indications are conveyed from a consumer to a merchant specific cryptocurrency addresses are assigned, allocated or otherwise associated with specific products. When payments arrive on these special addresses, merchants implicitly understand the purchase is intended for the associated product as there is a one-to-one correspondence between products and/or product specifications and addresses which provides a merchant means for determining which of their many products are being chosen by consumers.

For example, a sporting goods website ‘e-tailer’ merchant may have a product line including: a basketball, a tennis racket and a cricket bat. A specific and unique Bitcoin address may be assigned to each of these as follows thus forming associations between Bitcoin addresses and items offered for sale. The table illustrates.

| Item | Cryptocurrency Address |
|---|---|
| Basketball | 15VN7QKnbHjywpgV8Pn24GhCZ4sz6BreVP |
| Tennis Racket | 1Gysszfg4g6KMoQanhCzR2Ls47fDzVWop7 |
| Cricket Bat | 1BWsoAKvi3nVJYBsJrRp8PFbuqGChZ4kXG |

When this merchant of sporting goods monitors the blockchain to detect payments arriving on either of these addresses, blockchain purchase orders for goods will appear occasionally. If a payment appears on the address:
“15VN7QKrbHjywpgV8Pn24GhCZ4sz6BreVP”,
   then the merchant understands implicitly by way of the association between this address and the basketball that the payment is intended for the purchase of a basketball.

Of course, advertisements for basketballs must include the correct address, i.e. the address the merchant associated with the basketball in the table above. When an advertising administrator create s advertisements for basketballs he must assure that the correct address is used in the parameters definition of the advertisement device. In conventional retail systems where merchants use cryptocurrency addresses, they typically use a single address for all payments without regard to the item being purchased. A merchant address is similar to a bank account number in those systems AJI payments to the merchant may go to this single address. This is typical where product selection is indicated by means other than the Bitcoin transaction.

However, in these highly unique systems where the consumer and merchant are quite separated with no direct communications links therebetween by which a consumer may express his product choices, product selection is made by deduction in view of address associations with products and product configurations.

While the illustrative example immediately preceding this has three addresses for three discrete product items, some versions include more advanced product selection means permitting further specification of product configuration and details.

In another example, a single product may have many discrete Bitcoin addresses associated therewith, each to indicate a different product parameter specification and/or combinations of parameter choices. A pair of shoes typically demands customer specification of size and color. While the choice of a single model of shoes is effectively made via a single Bitcoin address association, where size and color parameters need also be specified, it may be necessary to include 16 distinct Bitcoin addresses with a single advertisement device of these systems.

Sometimes it is convenient for merchants to adopt a coding schemes in which Bitcoin addresses may be provided with certain character positions used to convey model, size and color information as human readable indications. It is to be understood that 16 completely random addresses may be effectively used, however in some preferred versions Bitcoin addresses may be used where a few of the leading characters are declared to assist systems administrators in using the address associations more effectively.

For example, Bitcoin address typically include a ‘1’ or ‘3’ as a first character, so, these systems respect that first character position and leave as either a ‘1’ or a ‘3’ However character position number two of a Bitcoin address may include any legal Bitcoin address character. Indeed all other characters of a Bitcoin address have no other significance.

So merchants of shoes may declare a specific shoe model to be associated with Bitcoin addresses having a leading character string of ‘1 PMP’. The ‘1’ specifies nothing of importance to the merchant while the‘PMP’ indicates to the merchant the model of shoe being purchased is the ‘Tribute Patent Leather Sandal’ for example. The merchant has elected ‘PMP’ as the product encoding associated with the Tribute Patent Leather Sandal by definition.

When a merchant fulfillment center detects a Bitcoin payment on one of its prescribed addresses having ‘PMP’ as leading characters, it is understood that the customer intends to purchase the shoe model ‘Tribute patent-leather sandals’ However, for this example the address specification is to carry additional information.

To specify the user's choice of size and color additional characters of a Bitcoin address may be used. For example a single letter‘B’ following the ‘PMP’ may indicate a color choice ‘black’. Consumers who choose ‘red’ shoes indicate their choice via Bitcoin addresses having ‘1PMPR’ as leading characters for example.

Users may make their color and sizechoices directly in the advertisement via user interface component or ‘web objects’ such as a dropdown box having a list of choices. By making selections in such web control device, ‘code behind’ the device operates to invoke the correct Bitcoin address which corresponds to the user selections when forming a Bitcoin transaction via the device's purchase trigger.

The table below presents an address set which serves to permit consumers color and size selections in conjunction with a particular model of shoe. i.e. ‘Tribune Patent Leather Sandals’.

| # | Bitcoin address | Color | size |
|---|---|---|---|
| 1 | 1PM P1884p7nLECt5pVBuC91 CAnt7M DTdhf3 | Blue | 6.5 |
| 2 | 1PM P2BrEW84w9NfMgrWP2WpufD69zCn748 | Blue | 7 |
| 3 | 1PM P3BeaC8vG3WPfcyl DXaUpcuFAzP5x5x | Blue | 7.5 |
| 4 | 1PM P4BuSk6uTKR4 7yxqhM3mM4xVXi9s0 4 | Blue | 8 |
| 5 | 1PM P5BK1BUqwPaq6RHlaclZE8fc9TNTUEd | Blue | 8.5 |
| 6 | 1PM P6B6Cw9Tc2vrkoBJqm jzmEzfzHSbwL8 | Blue | 9 |
| 7 | 1PM P7BBEsCNGaKyAXnRRhszNu68Fx3Tlvr | Blue | 9.5 |
| 8 | 1PM P8BesWM 4wvuDLdgZHdGK9JVUwTbfQaQ | Blue | 10 |
| 9 | 1PM P1GXBeEbFgHXy2AwsgZviUhTX9AzxM r | gunmetal | 6.5 |
| 10 | 1PMP2GaSqxFkHmHiMLDAzuvKSpMHrRm2cG | gunmetal | 7 |
| 11 | 1PM P3GJhoaksSPSZ87RUd32 u PmR46vUA | gunmetal | 7.5 |
| 12 | 1PM P4GWzzgNQ5R8bEZkJrM DqFr3um3Hw LH | gunmetal | 8 |
| 13 | 1PM P5GN5M BRf495eDiol2iH7 Uw5EjUDDgl | gunmetal | 8.5 |
| 14 | 1PM P6GsZqvsxAKCNhn9JtqYDhkoXblz7PT | gunmetal | 9 |
| 15 | 1PM P7GEhbi Q cZfq3BC5C3YeWBtqm 2vuvWD | gunmetal | 9.5 |
| 16 | 1PM P8GwoV8jT8Fbmh NtiUUoQteALX8WEUs | gunmetal | 10 |

The table forms index associations between qualified Bitcoin addresses and product specification including specific product model, size and color.

Because merchants have formed associations with particular Bitcoin addresses and the products and product configurations offered in these advertisements, a fulfillment center can implicitly determine details of the products being purchased by way of those same addresses, for example a fulfillment center in possession of information in the table above.

An advertisement in conformance with this teaching has at least one prescribed cryptocurrency address for which a product association has been made whereby payment on the address indicates a customer's product selection to a disconnected merchant fulfillment center

### Client Side Code Execution

It is an important aspect of some of these commerce platforms, that the web control user interfaces operate entirely autonomous without support from a conventional merchant checkout server. Typical web controls for commercial retail purchases must be in communication with a remote server operated or administered by the merchant or a merchant's agent. Product choices, customer shipping addresses, et cetera are transmitted from the website to the server where they are recorded for use in order fulfillment and processing. The e-commerce checkout platforms taught here are autonomous as they are not connected to any merchant server and have no direct communications therewith. As such, they operate entirely under the shell of a third-party website (i.e. Facebook, Instagram) and a user's local browser software. Accordingly, some versions of these web controls are coded in script languages which can be fully executed locally in the browser expressing the control without any information exchange with the merchant. Responses to user interactions with the control/advertisements may result in state changes of the URI values.

After a consumer makes product configuration changes and selections, and then ‘clicks’ the purchase trigger or‘Buy Now’ button, the control operates to invoke the so configured URI thus causing a local Bitcoin wallet to launch and parse the URI string which has been adjusted to reflect those choices made via the web control user interface. The user control does not send data about choices to the merchant nor to any external system, but rather only to the Bitcoin wallet on the local machine. Those choices are then encoded within a well-formed Bitcoin transaction and passed to the peer nodes of the distributed network for integration with the blockchain.

### Social Media Integrated Wallets and Browser Wallets

In some important variations, a web control device in accordance with this teaching may not use the Bitcoin URI to pass parametric values to a local Bitcoin wallet, but rather may be part of a website or website viewing apparatus (‘web browser’) having a built-in cryptocurrency wallet system(s) Some comprehensive high function websites maintain a membership of registered users and further maintain portions of the website specific and private with respect to those registered users.

One simple example of user specific content is a user profile. Only an authenticated member has access to her user profile. Sophisticated social media websites will soon incorporate a cryptocurrency wallet directly into their membership schemes. In these scenarios, the commercial purchase platforms of this disclosure do not pass parametric values to a local crypto wallet via URI, but rather pass parameters within the logic which administers the membership and presentation of webpages in which these web control systems reside.

In such configurations, the website server may receive user inputs such as product selection parameter (i.e. size and color choices) as well as purchase trigger clicks and use that information along with information recalled from a user profile such as the preferred shipping address specification and use these information elements to form a cryptocurrency transaction which operates as a purchase order as it carries all required information once transmitted to the blockchain.

While social media websites having integrated cryptocurrency wallets are the leading alternative version of special deployment of these devices, other alternatives also are possible. A client-side alternative exists when a cryptocurrency wallet is integrated with a web browser software package. When a web browser is sufficiently prepared with functionality which operates to effect wallet operations, the advertisement web controls taught herein do not require use of a URI to spawn the launch of an external software package (Bitcoin client), but rather states of the device are known to the browser code and the browser itself may invoke special purpose resident code to send cryptocurrency transactions configured as purchase orders for commercial products to peer-to-peer networks.

### Bitcoin URI

The final action taken by the user within the advertisement web control is a ‘click’ action on a command button web control sometimes arranged as a hyperlink or web control with a ‘Navigate to’ property, or other purchase trigger to invoke a ‘Buy Now’function. Upon invocation of the purchase trigger, the URI causes a local Bitcoin wallet engine to be launched and further to be populated with data from the advertisement control and the states of sub control elements therein. In preferred versions, the Bitcoin wallet engine (either stand alone as local application, integrated with web browser, or integrated with website) receives via URI a Bitcoin destination or output address (merchant address which corresponds to product selection in preferred modes), the price to be paid specified in cryptocurrency units, any key necessary for encoding delivery addresses, and sometimes flags which indicate to the cryptocurrency wallet engine that the transaction is one which should be processed in accordance with the special protocol which demands a customer delivery information be included as part of the transaction.

Accordingly some versions of these devices, methods and articles include for example a URI which may be expressed as:
URI=Bitcoin:1PMP6GsZqvsxAKCNhn9JtqYDhkoXblz7PT?EB=I&P=2.200&Key=19!&4x3

where ‘Bitcoin:’ specifies the URI type and causes the correct application (local Bitcoin wallet) to be launched when the URI is invoked.

the merchant's Bitcoin address arranged to carry product and product configuration specification is
‘1PNPGGsZqvzAKCNhn9JtqYDhkoXbl z7PT’

the parameter ‘EB=I’ is a Boolean variable which indicates special handling should be preferred to build a transaction which includes customer shipping address:

the parameter ‘Key=19!&4 x3’ is a key to be used to encrypt the shipping address in accordance with a prescribed scheme known to both the wallet and the merchant; and

the parameter ‘P=2.200’ is the price specified in cryptocurrency units

### Deterministic Address Series

It is not always preferred to have addresses which readily specify products being purchased especially to outside observers such as business competitors. In these cases, systems taught herein adopt schemes to conceal associations between addresses and products which are subject of a commercial advertisement arranged as a web control type user interface of this specification.

Deterministic Address Series

It is not always preferred to have addresses which readily specify in clear text or easily deciphered text products being purchased—especially with respect to outside observers such as business competitors. In these cases, systems taught herein may preferably adopt schemes to conceal associations between addresses and products which are subject of a commercial advertisement arranged as a web control type user interfaces of this specification.

In such cases an address scheme may be used in which any one address is used on a single or otherwise limited number of occasions but not reused thereafter. A merchant may allocate a seed and deterministic address generation scheme to generate a plurality of coupled addresses to be associated with a specific product being offered in the commerce platforms. An address rotation through this set of so-generated addresses permit advertisements for the identical product to each have a unique address. Only the merchant will have access to the address series and be able to determine which products are to be shipped to its customers. Competitors will not be able to perform any information data mining operations on the used addresses to glean commercial information therefrom as couplings between addresses for the same product can only be understood by the merchant as they are not able to be calculated by external parties

### Alternative Product Specification Schemes

It is within the essence of the whole invention that a product, product specification, product choice be carried by a Bitcoin transaction. While some preferred versions accomplish this by using discrete Bitcoin addresses for various choices as described previously, alternative schemes are readily devised to realize the same function while avoiding the use of addresses to convey product selections.

In one alternative scheme, a merchant can set a single Bitcoin address on which he receives all cryptocurrency transactions for retail commerce. Therefore, the address is inoperative for indicating the product being offered/purchased. However, within each transaction an encoding to indicate a customer's product choice can be included. Merchants receive all purchase orders as cryptocurrency transactions via the public blockchain and use a prescribed decoding scheme to extract product choice information which must be encoded into portions of the Bitcoin transaction distinct from the primary transaction output or Bitcoin address.

In one such scheme, a cryptocurrency transaction is configured with two or more ‘outputs’. In a first output the specified value (product price) is sent to an address belonging to the merchant. A second transaction output having a tiny amount or ‘dust’ value as it is sometimes called in the art is sent to a ‘pseudo-address’ which is specifically arranged to encode a product selection specification. Sometimes this dust value made include a‘marker’value to further signify additional information as well as information carried by characters from which the address is comprised. For example an output value of 0.00002 they be transmitted to an address specifically arranged to encode a product configuration specification. For the exact same product, and output value of 0.00003 may be used to indicate expedited shipping services is desired.

Thus a Bitcoin transaction having a plurality of outputs operates to carry payment in a first address for which the merchant has a private key and a product specification in a second (or subsequent) address for which the merchant may not have an associated private key since only superficial amounts are sent to this address those amounts may be sacrificed as forever understandable due to the absence of a private key.

Experts will appreciate that some uses of contrived Bitcoin addresses (public key hashes) will necessitate that the corresponding private key cannot be known. This occurs when an address (public key) is created from whole cloth rather than computed from a generated private key.

Despite not having a private key, the public key may be used to carry a data payload with the understanding that amounts transferred to that address are lost, the amounts being very small fractions of any appreciable value.

While such schemes to use ‘fake’ or contrived key hashes with no known corresponding private key are 100% functional for the purpose of conveying product selection information, these schemes are considered by many as abusive towards the Bitcoin network as this ‘extra’ data tends to bloat the blockchain placing a slight burden on the network for each bit of additional data. Such uses have been actively rallied against and in large part the protocol providing for the OP_Return field was brought forth in response to these types of data ‘stuffing’ hacks. Accordingly it is sometimes desirable to avoid use of addresses in this manner despite the fact that it does perfectly enabled means for conveying product selection to merchants.

In yet another encoding scheme, Bitcoin transaction provides for a‘multi-sig’ arrangement which defines a plurality of authorizing entities each having a public key hash. These extra public key hashes may be made to carry product selection information in a Bitcoin transaction. Multi-sig schemes are desirable in that they do not burden the UTXO with unspent outputs as does the technique described above. Network performance demands that the UTXO be free from unnecessary records which tend to bulk its size. However transaction bandwidth is still consumed with these multi-sig addresses which are in fact merely data carrying vehicles rather than actual authorizing entities. As such, this technique is desirable and useful, yet still imperfect. The inventor fully anticipates operable systems built around product and product configuration specifications configured with multi-sig type of Bitcoin transactions.

Of course clever software engineers will devised yet another distinct manner of encoding product selection information into various portions of cryptocurrency transactions. Accordingly, any particular encoding scheme is not critical to functionality. However, that a cryptocurrency transaction does indeed convey a customer's product choice to a merchant by way of the cryptocurrency transaction is included in concepts which enable in part the special unique commerce systems.

### Address Obfuscation/Encryption

Because certain uses of shipping address information is unauthorized and undesirable, it is advantageous to avoid posting same into the public blockchain where it might be readily mined by those having bad intent or improper design. In one of first simple scheme where a shipping address is abbreviated to fit within the limits of the OP_Return field size of 40 bytes, an additional obfuscation step may be adopted Data may simply be ‘scrambled in accordance with a very basic scheme to make the data appear random or hard to decipher. Merchants having knowledge of the means by which the data is scrambled may apply a reverse operation to retrieve the data back to a more usable state. Casual observers would be unable to capture street address information without extended effort. This possibility offers very good ‘lightweight’ protection of shipping address information.

In some cases, it is desirable to effect stronger protection of shipping data. In these instances, one may pass an encryption key to a consumer wallet which can be used during transaction formation steps. Specifically, the key may be used in a step in which a shipping address in clear text form is encrypted. Since a merchant is the only entity having a corresponding decryption key others are prevented from reconstructing the data in a form to reveal the customers shipping address.

In an advanced scheme an encryption of shipping address information may be encrypted in view of the same key pair used for the Bitcoin transaction. Since the merchant is already in possession of the private key complement of the Bitcoin address, that key pair may be used in rigorous schemes to conceal the shipping address from persons not in possession of the private key.

### Carrier Wave Signals

A most important aspect of these systems is the physical construct which may be interpreted by web browsers to bring about functionality described. An article fashioned as a modulated electronic or electromagnetic signal is a ‘carrier wave signal. A carrier wave signal is encoded by a temporal modulations to form a digital signal for example. Carrier wave signals which give rise to these web control systems may include signal portions defining, a purchase trigger, a cryptocurrency address; a price specification; and a product specification; among others.

Carrier wave signals arranged to encode these elements may be transmitted from a server computer to a client computer in a communications network such as the Internet. A web server which delivers webpages in response to requests initiated at a client computer running a web browser software package for example may transmit as part of a webpage a web control device in accordance with this specification.

Such web control device when presented within a browser and expressed visually whereby users may interact in therewith for example by ‘mouse clicks’ or ‘screen laps’, can give rise to the function and performance described herethroughout. Accordingly a carrier wave signal is an article manufactured for the purpose of being conveyed in communications networks to impart the methods and functions taught herein and a carrier wave signal as such is to be considered part of the claimed inventions.

### Displayed Prices

Since certain versions of these systems are embodied as a web-based advertisements, such versions may be dynamically responsive to changes in an exchange rate between a select first currency and the cryptocurrency upon which the system is based. While not a necessity, some versions nevertheless display product pricing in both bitcoin and dollars or euros for example.

An exchange rate continuously changes in view of open market trading on exchanges having appreciable trade volumes. Accordingly, some versions of these advertisements are arranged to have a fixed price in one denomination and a floating price in a second denomination. At the time the advertisement is served in a web page, a script may be executed to retrieve an instantaneous exchange rate value and multiply it by the fixed rate value to display a value in the second denomination.

Accordingly, in an initialization step high-performance versions of these systems include an action in which a current exchange rate is retrieved over the Internet and used to set the visual of the web control device, namely the label which indicates the sale price Thus, a merchant who would like to receive a prescribed value specified in dollars can always be assured enough of cryptocurrency is being conveyed with the order no matter what the exchange rate is at any given time Because transactions of these systems are necessarily done in cryptocurrency units, it is a necessity to convert product pricing specified in fiat to cryptocurrency equivalent values prior to forming a transaction which may be executed on the peer-to-peer cryptocurrency network(s).

As cryptocurrencies become more familiar to merchants and consumers, some versions of these systems will include product pricing exclusivity in cryptocurrency units such as Bitcoin and the need for exchange rate retrieval and conversions will be entirely obviated. Those system configurations are entirely anticipated.

One will now fully appreciate how cryptocurrency based commerce systems arranged as autonomous advertisements decoupled from merchants operate to effect a highly efficient retail platform having automated delivery mechanisms. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

It is claimed:

1. A method of effecting a purchase order comprising:
accessing from one or more memory devices computer-readable instructions, wherein the computer-readable instructions are executable by one or more processors of a computing device to:
detect a purchase trigger event;
recall a delivery address specification in response to the detecting of the purchase trigger event;
form a cryptocurrency transaction, the cryptocurrency transaction incorporating there called delivery address specification therein; and
transmit the cryptocurrency transaction into a peer to peer cryptocurrency network.

2. The method of claim 1, the computer-readable instructions further executable by the one or more processors to detect the purchase trigger event by detecting a click event on a command button of a graphical user interface.

3. The method of claim 1, the computer-readable instructions further executable by the one or more processors to recall the delivery address specification by recalling a delivery address justification from a user profile registry.

4. The method of claim 1, the computer-readable instructions further executable by the one or more processors to form the cryptocurrency transaction by forming a cryptocurrency transaction having a data payload portion, the data payload portion is arranged to carry data not directly part of a stored value transaction.

5. The method of claim 1, the computer-readable instructions further executable by the one or more processors to transmit the cryptocurrency transaction by conveying to the peer-to-peer or concurrency network a transaction or integration with a blockchain ledger.

6. The method of claim 2, wherein the purchase trigger event comprises a‘buy now’ instant purchase functionality.

7. The method of claim 4, wherein the data payload portion comprises an OP_Return field of a Bitcoin protocol.

8. The method of claim 1, the computer-readable instructions further executable by the one or more processors to select product options from a list of choices.

9. The method of claim 8, the computer-readable instructions further executable by the one or more processors to select the product options by manipulating a user interface web control and setting a default shipping address specification in a user profile of a coupled system.

10. The method of claim 1, the computer-readable instructions further executable by the one or more processors to set a default shipping address specification in a user profile of a coupled system.

11. An apparatus, comprising
one or more processors;
one or more memory devices;
computer-readable instructions, stored in the one or more memory devices and executable by the one or more processors to cause the apparatus to:
detect a purchase trigger event;
recall a delivery address specification in response to the detecting of the purchase trigger event;
form a cryptocurrency transaction, the cryptocurrency transaction incorporating there called delivery address specification therein; and
transmit the cryptocurrency transaction into a peer to peer cryptocurrency network.

12. The apparatus of claim 11, the computer-readable instructions further executable by the one or more processors to detect the purchase trigger event by detecting a click event on a command button of a graphical user interface.

13. The apparatus of claim 11, the computer-readable instructions further executable by the one or more processors to recall the delivery address specification by recalling a delivery address justification from a user profile registry.

14. The apparatus of claim 11, the computer-readable instructions further executable by the one or more processors to form the cryptocurrency transaction by forming a cryptocurrency transaction having a data payload portion, the data payload portion to be arranged to carry data not directly part of a stored value transaction.

15. The apparatus of claim 11, the computer-readable instructions further executable by the one or more processors to transmit the cryptocurrency transaction by conveying to the peer-to-peer or concurrency network a transaction or integration with a blockchain ledger.

16. The apparatus of claim 11, the computer-readable instructions further executable by the one or more processors to select product options by manipulating a user interface web control and setting a default shipping address specification in a user profile of a coupled system.

17. The apparatus of claim 1, the computer-readable instructions further executable by the one or more processors to set a default shipping address specification in a user profile of a coupled system.
